(19) United States
(12) Patent Application Publication
(10) Pub. No.: US 2025/0393089 A1
(43) Pub. Date: Dec. 25, 2025

(54) RADIO RESOURCE MANAGEMENT REQUIREMENTS FOR NEW RADIO DUAL CONNECTIVITY

(71) Applicant: Intel Corporation, Santa Clara, CA (US)

(72) Inventors: Hua LI, Beijing (CN); Meng ZHANG, Beijing (CN); Rui HUANG, Beijing (CN); In-Seok HWANG, Santa Clara, CA (US)

(21) Appl. No.: 18/881,227

(22) PCT Filed: Aug. 1, 2023
(86) PCT No.: PCT/US2023/071425

§ 371 Date: Jan. 3, 2025

Related U.S. Application Data
(60) Provisional application No. 63/394,866, filed on Aug. 3, 2022.

(51) Int. Cl. H04W 76/15; H04B 7/06; H04W 24/10; H04W 56/00

(52) U.S. Cl. CPC H04W 76/15; H04B 7/0626; H04W 24/10; H04W 56/0015

(57) ABSTRACT

The present disclosure specifies requirements to support multi-radio (MR)-dual connectivity (DC) radio resource management (RRM) requirements, including RRM requirements for frequency range 1 (FR1)+FR1 new radio (NR)-NR Dual Connectivity (NR-DC) scenarios.

### CROSS REFERENCE TO RELATED APPLICATION

The present application claims priority to U.S. Provisional App. No. 63/394,866 filed Aug. 3, 2022, the contents of which is hereby incorporated by reference in its entirety.

### FIELD

The present disclosure is generally related to wireless communication, cellular networks, cloud computing, edge computing, data centers, network topologies, and communication system implementations, and in particular, to radio resource management (RRM) requirements for new radio (NR) dual connectivity (DC).

### BACKGROUND

In Third Generation Partnership Project (3GPP) systems, RRM includes mechanisms that ensure the efficient use of the available radio resources and also provides mechanisms that enable fifth generation (5G)/NR networks to meet radio resource related requirements. In particular, RRM provides a means to manage (e.g., assign, re-assign, and release) radio resources taking into account single and multi-cell aspects.

5G/NR systems also support multi-radio DC (MR-DC), where a user equipment (UE) can transmit and receive data on multiple component carriers (CCs) from two cell groups to increase throughput. The two cell groups include a master cell group (MCG) and a secondary cell group (SCG). Typical NR-NR Dual Connectivity (NR-DC) scenarios involve CCs of the MCG operating in a first frequency range (FR1) and CCs of the SCG operating in a second frequency range (FR2), and the UE is configured with to perform measurements in both FRI and FR2. These measurements include RRM-related measurements. However, RRM requirements for FR1-FR1 NR-DC scenarios have not yet been defined.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings, in which:

FIG. 1 depicts an example network architecture;

FIG. 2 depicts an example wireless network;

FIG. 3 depicts example hardware resources;

FIG. 4 depicts an example measurement model; and

FIGS. 5, 6, and 7 depict example processes for practicing the various embodiments discussed herein.

### DETAILED DESCRIPTION

### 1. RRM Requirement for FR1+FR1 NR-DC Aspects

3GPP work item description (WID) RP-220977, titled “Even Further RRM enhancement for NR and MR-DC” introduced several enhancements for NR and multi-radio (MR)-dual connectivity (DC) radio resource management (RRM) requirements to be specified and/or defined, including RRM requirements for FR1-FR1 NR-NR Dual Connectivity (NR-DC) scenarios.

The frequency ranges in which NR can operate include frequency range 1 (FR1) and frequency range 2 (FR2). FR 1 includes a frequency range of 410 MHZ-7125 MHz. FR2 includes two sub-FRs, including: FR2-1 with a frequency range of 24250 MHz-52600 MHz and FR2-2 with a frequency range of 52600 MHZ-71000 MHZ. Additional aspects of FRI and FR2 are discussed in 3GPP TS 38.104 and [TS38133].

FR1+FR1 NR-DC band combinations were introduced in release (Rel)-16 and the relevant deployment scenarios are expected to be used globally. However, the RRM requirements for FR1+FR1 NR-DC are missing, which may negatively affect the overall performance in NR-DC scenarios. Specifically, one of the objectives of RP-220977 includes defining RRM requirements for FR1-FR1 NR-DC scenarios. The RRM requirements include the number of serving carriers. PSCell addition/release delay requirement, primary secondary cell group (SCG) cell (PSCell) change, conditional PSCell change delay, scheduling availability, and carrier-specific scaling factor (CSSF). Other Rel-15 requirements are not precluded. For R16 and R17 features, RRM requirements for FR1-FR1 NR-DC including HO with PSCell. SCG activation/deactivation and CPAC. The present disclosure defines new RRM requirements for FR1+FR1 NR-DC scenarios.

### 1.1. Number of Serving Carriers for NR-DC

Requirements for the number of service carriers for NR-DC are applicable for a UE 102 configured with the following number of serving NR component carriers (CCs): up to 2 NR downlink (DL) CCs in total in FR1, up to 8 NR DL CCs in total in FR2, with 1 UL in PCell. 1 uplink (UL) in PSCell. and up to 1 UL in each SCell.

In a first example, the requirements for FR1+FR1 NR-DC are applicable for the UE 102 configured with the following number of serving NR CCs: up to 10 NR DL CCs in total, with 1 UL in PCell. 1 UL in PSCell. and up to 1 UL in each SCell.

In a second example, the requirements for FR1+FR1 NR-DC are applicable for the UE 102 configured with the following number of serving NR CCs: up to 5 NR DL CCs in PCell and up to 5 DL CCs in PSCell, with 1 UL in PCell. 1 UL in PSCell, and up to 1 UL in each SCell.

In a third example, the requirements for FR1+FR1 NR-DC are applicable for the UE 102 configured with the following number of serving NR CCs: up to 10 NR DL CCs in total, with 1 UL in PCell. 1 UL in PSCell. and up to 8 UL SCell.

### 1.2. NR-DC Pscell Addition and Release Delay Requirement

The NR-DC addition and release delay requirements define the delay within which a UE 102 is able to configure a PSCell in NR-DC. The NR-DC addition and release delay requirements are applicable to an NR-DC capable UE 102. These requirements can also be applied to the PSCell change delay requirements (e.g., the delay within which the UE 102 is able to change a PSCell to another cell in NR-DC).

The PSCell release delay requirements apply for a UE 102 configured with a PCell and at least one PSCell. Upon receiving PSCell release in subframe n, the UE 102 accomplishes the release actions specified in [TS38331] no later than in slot

$$n + \frac{{T}_{RRC \_ delay}}{NR slot length} :$$

where T_{RRC_delay} is the RRC procedure delay as specified in [TS38331] (see table 1.2-1). The PCell interruption specified in clause 8.2 of [TS38133] is allowed only during the RRC reconfiguration procedure (see e.g., [TS38331]).

The PSCell addition delay requirements apply for a UE 102 configured with only PCell in FR1. Currently, PSCell addition delay requirements are defined for FR1+FR2 scenarios, wherein: upon receiving PSCell addition in subframe n, the UE 102 is capable to transmit a physical random access channel (PRACH) preamble towards a PSCell in FR2 no later than in subframe n+T_{config_PSCell}; and/or upon receiving a PSCell addition in subframe n, the UE 102 is capable to transmit a PRACH preamble towards a PSCell in FR2 no later than in slot

$$n + \frac{{T}_{config \_ PSCell}}{NR slot length} .$$

In either case, T_{config_PSCell} is defined as shown by equation 1.2-1; the parameters/variables of the equation 1.2-1 are provided in table 1.2-1.

$${T}_{config \_ PSCell} = {T}_{RRC \_ delay} + {T}_{p r o c e s s i n g} + {T}_{s e a r c h} + {T}_{Δ} + {T}_{PSCell \_ DU} + 2 milliseconds ( ms ) \qquad ( 1.2 - 1 )$$

TABLE 1.2-1

| Parameter | Description |
|---|---|
| T_{config}_{_{—}}_{PSCell} | the PSCell configuration delay |
| T_{RRC}_{_{—}}_{delay} | the RRC procedure delay as specified in [TS38331] |
| T_{processing} | the software (SW) processing time needed by a UE, including RF warm up period (e.g., |
| | radiofrequency (RF) circuitry warm-up period); |
| | T_{processing} = 40 ms |
| T_{search} | the time for AGC settling and PSS/SSS detection; |
| | If the target cell is known, T_{search} = 0 ms; |
| | If the target cell is unknown and the target cell Ês/lot ≥ −2 dB, T_{search} = 24 * Tᵣₛms |
| T_{Δ} | time for fine time tracking and acquiring full timing information of the target cell; |
| | T_{Δ} = 1 * Tᵣₛ ms for a known or unknown PSCell |
| Tᵣₛ | Tᵣₛ (see description of T_{Δ}) is the SMTC periodicity of the target cell if the UE has been |
| | provided with an SMTC configuration for the target cell in PSCell addition message, |
| | otherwise Tᵣₛ is the SMTC configured in the measObjectNR having the same SSB |
| | frequency and subcarrier spacing. |
| | If the UE is not provided SMTC configuration or measurement object on this frequency, the |
| | requirement in this clause is applied with Tᵣₛ = 5 ms assuming the SSB transmission |
| | periodicity is 5 ms. There is no requirement if the SSB transmission periodicity is not 5 ms. |
| T_{PSCell}_{_{—}}_{DU} | the delay uncertainty in acquiring the first available PRACH occasion in the PSCell; |
| | T_{PSCell}_{_{—}}_{DU} is up to the summation of SSB to PRACH occasion association period and 10 |
| | ms (the SSB to PRACH occasion associated period is defined in Table 8.1-1 of [TS38213]). |

In FR1 and FR2, the PSCell is known if it has been meeting the following conditions: during the last 5 seconds before the reception of the PSCell configuration command: the UE 102 has sent a valid measurement report for the PSCell being configured, and one of the SSBs measured from the PSCell being configured remains detectable according to the cell identification conditions specified in clause 9.3 of [TS38133]; and one of the SSBs measured from PSCell being configured also remains detectable during the PSCell configuration delay T_{config_PSCell} according to the cell identification conditions specified in clause 9.3 of [TS38133]; otherwise the PSCell is unknown. The PCell interruption specified in clause 8.2 of [TS38133] is allowed only during the RRC reconfiguration procedure (see e.g., [TS38331]). Additionally or alternatively, if the SSB-based measurement timing configuration (SMTC) periodicity of the target cell is not provided within a PSCell addition, release, or change message, and measObjectNRs having the same SSB frequency and subcarrier spacing configured by MN and SN have different SMTC. Tᵣₛ is the periodicity of one of the SMTC which is up to UE implementation.

According to various embodiments, some modifications are made to the aforementioned requirements and/or parameters for FR1+FR1 NR-DC. In some embodiments, the PSCell addition delay is modified so that T_{processing}=20 ms. This is because the PSCell is in the same frequency range (FR) with the PCell, which means that RF warming is not needed. Additionally or alternatively, the PSCell addition delay is modified such that T_{search}=3*Tᵣₛ ms for FR1-FR1 NR-DC. This is because the target cell is in FRI and no Rx beam sweeping is needed. In these embodiments, the UE 102 is capable of transmitting PRACH preamble towards the target PSCell no later than as specified previously for NR-DC, where the modified values for T_{processing} and T search override the existing ones in table 1.2-1.

### 1.3. Scheduling Availability of UE Performing RLM in Case of FR1-FR1 NR-DC

In legacy 3GPP standards, there is no FR1+FR2 scenario for NR-DC. In particular, legacy 3GPP standards specify that there are no scheduling restrictions on FRI serving cell(s) due to radio link monitoring performed on FR2 serving PCell and/or PSCell, and that there are no scheduling restrictions on FR2 serving cell(s) due to radio link monitoring performed on FRI serving PCell and/or PSCell.

Similar with inter-band carrier aggregation within FR1, there are no scheduling restrictions on FRI serving cell(s) due to radio link monitoring performed on FRI PSCell. In some embodiments, the 3GPP standards (e.g., [TS38133] § 8.1.7.4) are updated to include: There are no scheduling restrictions on FRI serving cell(s) due to radio link monitoring (RLM) performed on FR1 PSCell.

### 1.4. Carrier-Specific Scaling Factor

A measurement window (e.g., SMTC or CSI-RS resource period) of an SSB-based or CSI-RS-based measurement may not completely overlap with a measurement gap (MG) or other measurement period. For example, the measurement window and measurement period/MG may be non-overlapping, partially overlapping, or fully overlapping. In order to meet the specified/configured measurement accuracy requirements, the measurement period/MG may be scaled through a measurement delay scaling mechanism wherein a UE 102 can receive enough measurement samples of reference signals for evaluation, and then report the measurement results to the network within the per intra-frequency or inter-frequency measurement period. When the UE 102 is configured to monitor multiple measurement objects (MOs), the UE 102 derives or otherwise determines carrier-specific scaling factor (CSSF) values to scale the measurement delay requirements for performing measurement of the multiple MOs.

CSSF values are used to scale the measurement delay requirements given in clauses 9.2, 9.2A. 9.3, 9.3A, 9.4 of [TS38133]. NR PRS-based positioning measurements in clause 9.9 of [TS38133], and CSI-RS-based L3 measurement in clause 9.10 of [TS38133] when a UE 102 is configured to monitor multiple MOs. The CSSF values are categorized into CSSF_{outside_gap,i} and CSSF_{within_gap,i}. for the measurements conducted outside MGs and within MGs, respectively. Specifically, if the UE 102 is expected to perform measurement of MO i outside of an MG, then the UE 102 can derive the cell identity and measurement period based on CSSF_{outside_gap,i} for MO i; and if the UE 102 is expected to perform measurement of MO i inside an MG, then the UE 102 can derive the cell identity and measurement period based on CSSF_{within_gap,i} for MO i.

For intra-frequency measurements, the parameter CSSFᵢₙₜᵣₐ is a CSSF determined according to CSSF_{outside_gap,i} as discussed herein and/or in [TS38133] § 9.1.5.1 for measurement(s) conducted outside MGs (e.g., when intra-frequency SMTC is fully non-overlapping or partially overlapping with MGs or NCSG), or according to CSSF_{within_gap,i} as discussed herein and/or in [TS38133] § 9.1.5.2 for measurement(s) conducted within MGs (e.g., when intra-frequency SMTC is fully overlapping with MGs). In some examples, the parameter CSSFᵢₙₜᵣₐ is determined according to CSSF_{within_ncsg,i} as discussed herein and/or in [TS38133] § 9.1.5.3 for measurement(s) conducted within NCSG (e.g., when intra-frequency SMTC is fully overlapping with an NCSG). The calculated/derived CSSFᵢₙₜᵣₐ value is used to scale or otherwise adjust the time period for PSS/SSS detection, the time period for time index detection, and/or measurement period for intra-frequency measurements with or without MGs (see e.g., [TS38133] §§ 9.2.5, 9.2.6, 9.10).

For inter-frequency measurements, the parameter CSSFᵢₙₜₑᵣ is a CSSF determined according to CSSF_{outside_gap,i} as discussed herein and/or in [TS38133] § 9.1.5.1 for measurement(s) conducted outside MGs or NCSG (e.g., when inter-frequency SMTC is fully non-overlapping or partially overlapping with MGs), according to CSSF_{within_gap,i} as discussed herein and/or in [TS38133] § 9.1.5.2 for measurement(s) conducted within MGs (e.g., when inter-frequency SMTC is fully overlapping with MGs), or according to CSSF_{within_nesg,i} as discussed herein and/or in [TS38133] § 9.1.5.x for measurement(s) conducted within NCSG (e.g., when inter-frequency SMTC is fully overlapping with NCSG). The calculated/derived CSSFᵢₙₜₑᵣ value is then used to scale or otherwise adjust the time period for PSS/SSS detection, the time period for time index detection, and/or measurement period for intra-frequency measurements with or without MGs (see e.g., [TS38133] §§ 9.3.4, 9.3.5, 9.3.9, and 9.10).

If concurrent MGs are configured by the network (e.g., RAN 104 or RAN node 114), subject to UE capability, the term of the union of concurrent MGs in the following discussion refer to non-dropped MG occasions after accounting for MG collisions as specified in clause 9.1.8.3 of [TS38133] from all the configured MG patterns. The term of the associated MG in concurrent MGs in the following clauses refer to non-dropped MG occasions associated by MO i after accounting for MG collisions as specified in clause 9.1.8.3 of [TS38133].

### 1.4.1. Monitoring of Multiple Layers Outside Gaps

For a UE 102 supporting concurrent gaps and when concurrent gaps are configured the carrier-specific scaling factor CSSF_{outside_gap,i} for MO i is derived and applied to following measurement types: SSB-based intra-frequency measurement with no MG in clause 9.2.5 of [TS38133] and 9.2A.5 of [TS38133], when none of the SMTC occasions of this intra-frequency MO are overlapped by the MG or the union of concurrent MGs; SSB-based intra-frequency measurement with no MG in clause 9.2.5 of [TS38133] and 9.2A.5 of [TS38133], when part of the SMTC occasions of this intra-frequency MO are overlapped by the MG or the union of concurrent MGs; CSI-RS-based intra-frequency measurement in clause 9.10.2 of [TS38133], when none of CSI-RS resources for L3 measurement of this intra-frequency MO are overlapped by the MG or the union of concurrent MGs; CSI-RS-based intra-frequency measurement in clause 9.10.2 of [TS38133], when all CSI-RS resources for L3 measurement of this intra-frequency MO are partially overlapped by the MG or the union of concurrent MGs; SSB-based inter-frequency measurement with no MG in clause 9.3.9 of [TS38133], when none of the SMTC occasions of this inter-frequency MO are overlapped by the MG or the union of concurrent MGs, if the UE 102 supports interFrequencyMeas-NoGap-r16 and the flag interFrequencyConfig-NoGap-r16 is configured by the Network; and/or SSB-based inter-frequency measurement with no MG in clause 9.3.9 of [TS38133], when part of the SMTC occasions of this inter-frequency MO are overlapped by the MG or the union of concurrent MGs, if UE 102 supports interFrequencyMeas-NoGap-r16 and the flag interFrequencyConfig-NoGap-r16 is configured by the Network.

Otherwise, the carrier-specific scaling factor CSSF_{outside_gap,i} for MO i is derived and applied to following measurement types: SSB-based intra-frequency measurement with no MG in clause 9.2.5 of [TS38133] and 9.2A.5 of [TS38133], when none of the SMTC occasions of this intra-frequency MO are overlapped by the MG or concurrent MGs; SSB-based intra-frequency measurement with no MG in clause 9.2.5 of [TS38133] and 9.2A.5 of [TS38133], when part of the SMTC occasions of this intra-frequency MO are overlapped by the MG or concurrent MGs; for a UE 102 in E-UTRA-NR dual connectivity operation, NR SSB-based inter-RAT MO configured by the E-UTRAN PCell on an NR serving carrier: the SSB is completely contained in the active BWP of the UE 102, and none or part of the SMTC occasions of this inter-RAT MO are overlapped by the MG or concurrent MGs; CSI-RS-based intra-frequency measurement in clause 9.10.2 of [TS38133], when none of CSI-RS resources for L3 measurement of this intra-frequency MO are overlapped by the MG or concurrent MGs; CSI-RS-based intra-frequency measurement in clause 9.10.2 of [TS38133], when all CSI-RS resources for L3 measurement of this intra-frequency MO are partially overlapped by the MG or concurrent MGs; SSB-based inter-frequency measurement with no MG in clause 9.3.9 of [TS38133], when none of the SMTC occasions of this inter-frequency MO are overlapped by the MG or concurrent MGs, if UE 102 supports interFrequencyMeas-NoGap-r16 and the flag interFrequencyConfig-NoGap-r16 is configured by the Network; SSB-based inter-frequency measurement with no MG in clause 9.3.9 of [TS38133], when part of the SMTC occasions of this inter-frequency MO are overlapped by the MG or concurrent MGs, if UE 102 supports interFrequencyMeas-NoGap-r16 and the flag interFrequencyConfig-NoGap-r16 is configured by the Network; for a UE 102 in E-UTRA-NR dual connectivity operation, NR SSB-based inter-RAT MO configured by the E-UTRAN PCell on an NR serving carrier: the SSB is completely contained in the active BWP of the UE 102, and none or part of the SMTC occasions of this inter-RAT MO are overlapped by the MG; and/or Intra-frequency RSSI and channel occupancy measurement with no MG on a carrier subject to CCA when SMTC and RMTC are overlapping and RMTCs are not fully overlapped with MG(s). The UE 102 is expected to conduct the measurement of this MO i only outside the MGs.

The number of frequency layers for SSB measurements includes the total number of MOs with ssb-ConfigMobility configured, or ssb-ConfigMobility not configured but csi-rs-ResourceConfigMobility configured with associatedSSB.

If ssbfrequency, smtc1, smtc2 and ssbSubcarrierSpacing are same in multiple MOs, the multiple MOs are counted as one SSB frequency layer. If the higher layer signaling in [TS38331] of smtc2 is present and smtc1 is fully overlapping with MGs and smtc2 is partially overlapping with MGs, CSSF_{outside_gap,i} and requirements derived from CSSF_{outside_gap,i} are not specified.

The UE cell identification and measurement periods derived based on CSSF_{outside_gap,i} in clauses 9.2.5.1, 9.2.5.2 and 9.10.2 of [TS38133] may be extended for MOs of which the cell identification and measurement periods are overlapped with T_{measure_SFTD1} specified in clause 9.3.8 of [TS38133] when no MGs are provided.

The requirements in this clause apply provided that: (i) the SMTC on all CCs and inter-frequency layers without MG in FR2 have the same offset, and one of following conditions is met: if smtc2 is configured on any FR2 CC, all CCs have the same configuration for smtc1, and all CCs configured with smtc2 have the same configuration for smtc2; if smtc2 is not configured on any FR2 CC, the total number of different SMTC periodicities on all serving CCs and inter-frequency layers without MG does not exceed 4; and/or (ii) the starting point of the first 5 ms window for CSI-RS measurement as defined in clause 9.10.1 on all CCs in FR2 is same and one of following conditions is met: if any CSI-RS resource is configured in the second 5 ms window for CSI-RS measurement as defined in clause 9.10.1 on any FR2 CC, all CCs with CSI-RS resources only in the first 5 ms window have the same CSI-RS resource periodicity, and all CCs with CSI-RS resources both in the first and the second 5 ms window have the same CSI-RS resource periodicity; and if no CSI-RS resource is configured in the second 5 ms window for CSI-RS measurement as defined in clause 9.10.1 on any FR2 CC, the total number of different CSI-RS resources periodicities on all serving CCs does not exceed 3. In some examples, longer delays for cell identification and measurement periods derived based on CSSF_{outside_gap,i} in clauses 9.2.5.1, 9.2.5.2 of [TS38133] can be expected, if the UE 102 is configured with more than 4 different SMTC periodicities on FR2 serving carriers. The longer delay applies for the FR2 intra-frequency MOs with the longest SMTC periodicity/periodicities.

In legacy 3GPP standards, CSSF for SSB-based and CSI-RS-based L3 measurements performed outside gaps and inside gaps are defined for FR1+FR2 NR-DC (e.g., CSSF_{outside_gap,i} and CSSF_{within_gap,i}, respectively).

### 1.4.1.1. NR-DC Mode: Carrier-Specific Scaling Factor for SSB-Based and CSI-RS Based L3 Measurements Performed Outside Gaps

In FR1+FR1 NR-DC, two (2) searchers are assumed wherein a first searcher is dedicated for primary CC (PCC), half of a second searcher is dedicated to primary secondary CC (PSCC), and the remaining half of the second searcher is shared among FRI secondary CCs (SCCs) and FR1 SCC. For SCC measurements on FR1 PSCell, there are two scenarios: (1) Intra-frequency CA on PSCell; and (2) Inter-frequency CA without gap on PSCell. The measurement will be shared between PCell SCC and PSCell SCC. Therefore, CSSF_{outside_gap,i} for FR1+FR1 is as shown by Table 1.4.1.1-1 and/or Table 1.4.1.1-2

For a UE 102 configured with NR-DC operation, the carrier-specific scaling factor CSSF_{outside_gap,i} for intra-frequency SSB-based measurement, inter-frequency SSB-based measurements performed outside measurements gaps and intra-frequency CSI-RS-based L3 measurement are as specified in Table 1.4.1.1-1 and/or Table 1.4.1.1-2.

TABLE 1.4.1.1-1
CSSF_{outside}_{_{—}}_{gap, i} scaling factor for FR1 + FR1 NR-DC mode

| | | | | | CSSF_{outside}_{_{—}}_{gap, i} |
|---|---|---|---|---|---|
| | CSSF_{outside}_{_{—}}_{gap, i} | CSSF_{outside}_{_{—}}_{gap, i} | CSSF_{outside}_{_{—}}_{gap, i} | CSSF_{outside}_{_{—}}_{gap, i} | for inter- |
| | for FR1 | for FR1 | for FR1 | for FR1 | frequency MO |
| Scenario | PCC | SCC | PSCC | PSCell SCC | with no MG |
| FR1 + FR1 NR- | 1 + N_{PCC}_{_{—}}_{CSIRS} | 2 × (N_{SCC}_{_{—}}_{SSB} + | 2 × (1 + | 2 × (N_{SCC}_{_{—}}_{SSB} + | 2 × (N_{SCC}_{_{—}}_{SSB +} |
| DC (FR1 PCell | | Y + 2 × | N_{PSCC}_{_{—}}_{CSIRS}) ^{Note 2} | Y + 2 × | Y + 2 × |
| and FR1 PScell) ^{Note 1} | | N_{SCC}_{_{—}}_{CSIRS}) | | N_{SCC}_{_{—}}_{CSIRS}) | N_{SCC}_{_{—}}_{CSIRS}) |

^{Note 1}
NR-DC in Rel-18 includes the scenarios where all serving cells in MCG in FR1 and all serving cells in SCG in FR2.
^{Note 2}
CSSF_{outside}_{_{—}}_{gap, i} = 1 if no SCell is configured and no inter-frequency MO without gap and only SSB based L3 measurement is configured on PSCC; CSSF_{outside}_{_{—}}_{gap, i} = 2 if no SCell is configured and no inter-frequency MO without gap and either both SSB and CSI-RS based L3 configured or only CSI-RS based L3 measurement is configured on PSCC.
Note 3:
Y is the number of configured inter-frequency SSB based frequency layers without MG that are being measured outside of MG; otherwise, it is 0.
Note 4:
N_{PCC}_{_{—}}_{CSIRS} = 1 if PCC is with either both SSB and CSI-RS based L3 configured or only CSI-RS based L3 measurement configured; otherwise, N_{PCC}_{_{—}}_{CSIRS} = 0.
Note 5:
NP_{SCC}_{_{—}}_{CSIRS} = 1 if PSCC is with either both SSB and CSI-RS based L3 configured or only CSI-RS based L3 measurement configured; otherwise, N_{PSCC}_{_{—}}_{CSIRS} = 0.
Note 6:
N_{SCC}_{_{—}}_{CSIRS} = Number of configured SCell(s) with either both SSB and CSI-RS based L3 measurement configured or only CSI-RS based L3 measurement configured
Note 8:
N_{SCC}_{_{—}}_{SSB} = Number of configured SCell(s) with only SSB based L3 measurement configured, which is measured without MG.

TABLE 1.4.1.1-2
CSSF_{outside}_{_{—}}_{gap, i} scaling factor for NR-DC mode

| | | | | | CSSF_{outside}_{_{—}}_{gap, i} | CSSF_{outside}_{_{—}}_{gap, i} |
|---|---|---|---|---|---|---|
| | | | | | for FR2 SCC | for inter- |
| | | | | | where neighbor | frequency |
| | CSSF_{outside}_{_{—}}_{gap, i} | CSSF_{outside}_{_{—}}_{gap, i} | CSSF_{outside}_{_{—}}_{gap, i} | CSSF_{outside}_{_{—}}_{gap, i} | cell measurement | MO with no |
| Scenario | for FR1 PCC | for FR1 SCC | for FR1 PSCC | for FR2 PSCC | is not required | MG |
| FR1 + FR2 | 1 + N_{PCC}_{_{—}}_{CSIRS} | 2 × (N_{SCC}_{_{—}}_{SSB} + | N/A | 2 × (1 + | 2 × (N_{SCC}_{_{—}}_{SSB} + | 2 × (N_{SCC}_{_{—}}_{SSB} + |
| NR-DC (FR1 | | Y + 2 × | | N_{PSCC}_{_{—}}_{CSIRS}) ^{Note 2} | Y + 2 × | Y + 2 × |
| PCell and | | N_{SCC}_{_{—}}_{CSIRS}) | | | N_{SCC}_{_{—}}_{CSIRS}) | N_{SCC}_{_{—}}_{CSIRS}) |
| FR2 PScell) ^{Note 1} | | | | | | |
| FR1 + FR1 | 1 + N_{PCC}_{_{—}}_{CSIRS} | 2 × (N_{SCC}_{_{—}}_{SSB} + | 2 × (1 + | N/A | N/A | 2 × (N_{SCC}_{_{—}}_{SSB} + |
| NR-DC (FR1 | | Y + 2 × | N_{PSCC}_{_{—}}_{CSIRS}) ^{Note 2} | | | Y + 2 × |
| pCell and | | N_{SCC}_{_{—}}_{CSIRS}) | | | | N_{SCC}_{_{—}}_{CSIRS}) |
| FR1 PScell) | | | | | | |

^{Note 1}
NR-DC in Rel-15 only includes the scenarios where all serving cells in MCG in FR1 and all serving cells in SCG in FR2.
^{Note 2}
CSSF_{outside}_{_{—}}_{gap, i} = 1 if no SCell is configured and no inter-frequency MO without gap and only SSB based L3 measurement is configured on PSCC; CSSF_{outside}_{_{—}}_{gap, i} = 2 if no SCell is configured and no inter-frequency MO without gap and either both SSB and CSI-RS based L3 configured or only CSI-RS based L3 measurement is configured on PSCC.
Note 3:
Y is the number of configured inter-frequency SSB based frequency layers without MG that are being measured outside of MG; otherwise, it is 0.
Note 4:
N_{PCC}_{_{—}}_{CSIRS} = 1 if PCC is with either both SSB and CSI-RS based L3 configured or only CSI-RS based L3 measurement configured; otherwise, N_{PCC}_{_{—}}_{CSIRS} = 0.
Note 5:
N_{PSCC}_{_{—}}_{CSIRS} = 1 if PSCC is with either both SSB and CSI-RS based L3 configured or only CSI-RS based L3 measurement configured; otherwise, N_{PSCC}_{_{—}}_{CSIRS} = 0.
Note 6:
N_{SCC}_{_{—}}_{CSIRS} = Number of configured SCell(s) with either both SSB and CSI-RS based L3 measurement configured or only CSI-RS based L3 measurement configured
Note 8:
N_{SCC}_{_{—}}_{SSB} = Number of configured SCell(s) with only SSB based L3 measurement configured, which is measured without MG.

1.4.2. Monitoring of Multiple Layers within Gaps

For a UE 102 supporting concurrent gaps and when concurrent gaps are configured the carrier-specific scaling factor CSSF_{within_gap,i} for a MO i is derived and applied to following measurement types for the associated MG: SSB-based intra-frequency MO with no MG in clause 9.2.5 of [TS38133] and 9.2A.5 of [TS38133], when all of the SMTC occasions of this intra-frequency MO are overlapped with the MG or associated MG in concurrent MGs, or part of the SMTC occasions of this intra-frequency MO are overlapped with the associated MG and all the SMTC occasions of this intra-frequency MO are overlapped with the union of all the MGs; SSB-based intra-frequency MO with MG in clause 9.2.6 of [TS38133] and 9.2A.6 of [TS38133]; CSI-RS-based inter-frequency measurement in clause 9.10.3 of [TS38133], when CSI-RS resources for L3 measurement of this inter-frequency MO are overlapped by the MG or the associated MG in concurrent MGs; CSI-RS-based inter-frequency measurement in clause 9.10.3 of [TS38133], when CSI-RS resources for L3 measurement of this inter-frequency MO are partially overlapped by the MG or the associated MG in concurrent MGs; CSI-RS-based intra-frequency measurement in clause 9.10.2 of [TS38133], when all CSI-RS resources for L3 measurement of this intra-frequency MO are partially overlapped with the associated MG and all CSI-RS resources for L3 measurement of this intra-frequency MO are overlapped with the union of the configured concurrent MGs; SSB-based inter-frequency MO with MG in clause 9.3.4 of [TS38133]; SSB-based inter-frequency MO without MG for UE 102 capable of interFrequencyMeas-NoGap in clause 9.3.9 of [TS38133], when all of the SMTC occasions of this inter-frequency MO are overlapped with the MG or associated MG in concurrent MGs, or part of the SMTC occasions of this inter-frequency MO are overlapped with the associated MG and all the SMTC occasions of this inter-frequency MO are overlapped with the union of all the MGs, or part of the SMTC occasions of this inter-frequency MO are overlapped by the MG or associated MG in concurrent MGs and the flag interFrequencyConfig-NoGap-r16 is not configured by the Network; NR PRS-based measurements for positioning in clause 9.9 of [TS38133]; and/or E-UTRA Inter-RAT MO in clauses 9.4.2 and 9.4.3 of [TS38133].

Otherwise, the carrier-specific scaling factor CSSF_{within_gap,i} for a MO i derived in this chapter is applied to following measurement types: SSB-based intra-frequency MO with no MG in clause 9.2.5 of [TS38133] and 9.2A.5 of [TS38133], when all of the SMTC occasions of this intra-frequency MO are overlapped by the MG or concurrent MGs; SSB-based intra-frequency MO with MG in clause 9.2.6 of [TS38133] and 9.2A.6 of [TS38133]; CSI-RS-based inter-frequency measurement in clause 9.10.3 of [TS38133], when CSI-RS resources for L3 measurement of this inter-frequency MO are overlapped by the MG or concurrent MGs; CSI-RS-based inter-frequency measurement in clause 9.10.3 of [TS38133], when CSI-RS resources for L3 measurement of this inter-frequency MO are partially overlapped by the MG or concurrent MGs; SSB-based inter-frequency MO with MG in clause 9.3.4 of [TS38133]; SSB-based inter-frequency MO without MG for UE 102 capable of interFrequencyMeas-NoGap in clause 9.3.9 of [TS38133], when all of the SMTC occasions of this inter-frequency MO are overlapped by the MG or concurrent MGs, or part of the SMTC occasions of this inter-frequency MO are overlapped by the MG or concurrent MGs, but the flag interFrequencyConfig-NoGap-r16 is not configured by the Network; Intra-frequency RSSI/CO measurement with MG in clause 9.2A.7 of [TS38133]; Intra-frequency RSSI/CO measurement with no MG in clause 9.2A.7 when all of the RMTC occasions of this intra-frequency RSSI/CO measurement are overlapped by the MG(s); Inter-frequency RSSI/CO measurement in clause 9.3A.8 of [TS38133] and 9.3A.9 of [TS38133]; E-UTRA Inter-RAT MO in clauses 9.4.2 of [TS38133] and 9.4.3 of [TS38133]; NR PRS-based measurements for positioning in clause 9.9 of [TS38133]; E-UTRA Inter-RAT reference signal time difference (RSTD) and Enhanced Cell ID (E-CID) measurements in clauses 9.4.4 and 9.4.5 of [TS38133]; for a UE 102 in E-UTRA-NR dual connectivity operation, NR SSB-based Inter-RAT MO configured by the E-UTRAN PCell (see e.g., 3GPP TS 36.133 § 8.17.4) on an NR serving carrier the SSB is not completely contained in the active BWP of the UE 102, or all of the SMTC occasions of this inter-RAT MO are overlapped by the MG; NR SSB-based Inter-RAT MO configured by the E-UTRAN PCell (see e.g., 3GPP TS 36.133 § 8.17.4) on an NR non-serving carrier; E-UTRAN Inter-frequency MO configured by the E-UTRAN PCell (see e.g., 3GPP TS 36.133 § 8.17.3) and by the E-UTRAN PSCell (see e.g., 3GPP TS 36.133 § 8.19.3); E-UTRAN Inter-frequency RSTD measurement configured by the E-UTRAN PCell (see e.g., 3GPP TS 36.133 § 8.17.15); UTRA Inter-RAT MO configured by the E-UTRAN PCell (see e.g., 3GPP TS 36.133 §§ 8.17.5 to 8.17.12); and/or GSM Inter-RAT measurements configured by the E-UTRAN PCell (see e.g., 3GPP TS 36.133 §§ 8.17.13 and 8.17.14).

The UE 102 is expected to conduct the measurement of this MO i only within the MG or the associated MG if concurrent MGs are configured. If UE 102 is configured with concurrent MGs and an association between MO i and certain MG is provided, the requirements are defined assuming the UE 102 shall conduct the measurement of this MO i within the associated MG.

If the higher layer signaling in [TS38331] of smtc2 is present and smtc1 is fully overlapping with MGs and smtc2 is partially overlapping with MGs, CSSF_{within_gap,i} and requirements derived from CSSF_{outside_gap,i} are not specified.

Number of SSB layers should include SSB for mobility and that as associated SSB for CSI-RS mobility, the ssbfrequency is counted only once if the ssbfrequency for mobility and associated SSB are the same, or ssbfrequency and smtc in multiple MOs are the same. In some examples, it is for future study (FFS) how to add the layer corresponding to the associated SSB for an MO with only CSI-RS measurement configured.

1.4.2.1. NR-DC: Carrier-Specific Scaling Factor for SSB-Based and CSI-RS-Based L3 Measurements Performed within Gaps

When one or more MOs are monitored within MGs, the carrier specific scaling factor for a target MO with index i is designated as CSSF_{within_gap,i} and is derived as described infra. When NR PRS-based measurements for positioning are configured on one or more positioning frequency layers within MGs, the CSSF for a target measurement on a positioning frequency layer with index i is designated as CSSF_{within_gap,i} and is derived as described infra and/or in clause 9.1.5.2.4 of [TS38133]. NR positioning measurement requirements for long periodicity measurements apply in case all PRS resources in the PFL are configured with periodicity >160 ms.

For UE 102 supporting per-FR gap, for each MO i that are measured based on an effective MG repetition period (MGRP) as defined in clause 9.1.2 of [TS38133], CSSF_{within_gap,i} used for deriving the measurement requirements is defined as 2*N_{with_CSI-RS}+N_{SSB_only}, where N_{with_CSI-RS} is the number of MOs with either both SSB and CSI-RS-based L3 configured or only CSI-RS-based L3 measurement configured in the same FR as MO i, and N_{SSB_only} is the number of MOs with only SSB-based L3 measurement configured in the same FR as MO i.

If MO i refers to a long-periodicity measurement which is any of: an E-UTRA RSTD measurement with periodicity Tprs>160 ms or with periodicity Tprs=160 ms but prs-MutingInfo-r9 is configured, or an NR measurement for positioning frequency layer i with T_{available_PRS,i}>160 ms, where T_{available_PRS,i} is defined in clauses 9.9.2.5, 9.9.3.5 and 9.9.4.5 of [TS38133] for RSTD, PRS-RSRP and UE Rx-Tx time difference measurements, respectively; Then CSSF_{within_gap,i}=1. Otherwise, the CSSF_{within_gap,i} for other MOs (including E-UTRA RSTD measurement with periodicity Tprs=160 ms) participate in the gap competition and the CSSF_{within_gap,i} are derived as below.

When multiple positioning frequency layers are configured, for each positioning frequency layer i, CSSF_{within_gap,i} is derived with the following steps assuming no other positioning frequency layer is configured; for each RRM frequency layer i, CSSF_{within_gap,i} is derived as follows: an intermediate CSSF_{within_gap,i,k} is derived with the following steps assuming only positioning frequency layer k is configured, and CSSF_{within_gap,i}=max (CSSF_{within_gap,i,k}), where k=0 . . . . K−1, and K is the number of configured positioning frequency layers.

For each MG j not used for an RSTD measurement with periodicity Tprs>160 ms or with periodicity Tprs=160 ms but prs-MutingInfo-r9 is configured within an arbitrary 160 ms period, count the total number of intra-frequency MOs and inter-frequency/inter-RAT MOs and NR PRS measurements on all positioning frequency layers which are candidates to be measured within a gap j (e.g., an MG j) An NR MO with SSB measurement configured is a candidate to be measured in a gap if its SMTC duration is fully covered by the MGL excluding RF switching time. For intra-frequency NR MOs, if the higher layer in [TS38331] signaling of smtc2 is configured, the assumed periodicity of SMTC occasions corresponds to the value of higher layer parameter smtc2; otherwise the assumed periodicity of SMTC occasions corresponds to the value of higher layer parameter smtc1. An NR MO with CSI-RS measurement configured is a candidate to be measured in a gap if the window confining all CSI-RS resources are fully covered by the MGL excluding RF switching time. A positioning frequency layer is counted as candidate for a MG occasion if at least one PRS resource on that positioning frequency layer is fully covered by the MGL excluding RF switching time.

For UEs 102 which support and are configured with per-FR gaps, the counting is done on a per-FR basis, and for UEs 102 which are configured with per-UE gaps the counting is done on a per-UE basis. For UEs which support and are configured with per-FR gaps, the CSSF requirements do not apply when NR PRS measurement in one FR gap collides with SSB/CSI-RS/PRS measurements in the other FR gap in time domain.

Currently, if the number of configured inter-frequency and inter-RAT measurement objects and NR PRS measurements on all positioning frequency layers is non-zero and the UE 102 is configured with per-UE gaps, or if the UE 102 is configured with per-FR gaps: FRI and FR2 intra-frequency MOs belong to group A; inter-frequency and inter-RAT MOs and up to one NR PRS measurement on any one positioning frequency layer belong to group B; M_{groupA,i,j} is the sum of the number of FRI intra-frequency MOs M_{intra-FR1,i,j} and the number of FR2 intra-frequency MOs M_{intra-FR2,i,j}, including both SSB-based and CSI-RS-based, which are candidates to be measured in gap j where the MO i is also a candidate, otherwise M_{groupA,i,j} equals 0; and/or M_{groupBi,j} is the number of NR inter-frequency layers including both SSB-based and CSI-RS-based, EUTRA inter-RAT and UTRA inter-RAT MOs and up to one positioning frequency layer, which are candidates to be measured in gap j where the MO i is also a candidate, otherwise M_{groupB,i,j} equals 0.

Currently, if the number of configured inter-frequency and inter-RAT MOs and NR PRS measurements on all positioning frequency layers is zero and the UE 102 is configured with per-UE gaps: FR1 intra-frequency MOs belong to group A; FR2 intra-frequency MOs belong to group B; M_{groupA,i,j} is the number of FR1 intrafrequency MOs M_{intra-FR1,i,j}, including both SSB-based and CSI-RS based, which are candidates to be measured in gap j where the MO i is also a candidate, otherwise M_{groupA,i,j} equals 0; and M_{groupBi,j} is the number of FR2 intra-frequency MOs M_{intra-FR2,i,j}, including both SSB-based and CSI-RS based, which are candidates to be measured in gap j where the MO i is also a candidate, otherwise M_{groupB,i,j} equals 0.

Additionally, the parameter M_{tot,i,j} is the total number of group A and group B MOs which are candidates to be measured in gap j where the MO i is also a candidate; otherwise M_{tot,i,j} equals 0. In other words M_{tot,i,j}=M_{groupA,i,j}+M_{groupB,i,j}.

For each MG j used for a long-periodicity measurement defined above, M_{intra,i,j}=M_{inter,i,j}=M_{tot,i,j}=0. The carrier specific scaling factor CSSF_{within_gap,i} is given by (A) and (B):
(A) If measGapSharingScheme is equal sharing, CSSF_{within_gap,i}=max(ceil(Rᵢ×M_{tot,i,j})), where j=0 . . . (160/MGRP)−1;
(B) If measGapSharingScheme is not equal sharing and:
   a) MO i is a group A MO, and CSSF_{within_gap,i} is the maximum among:
      i) ceil(R₁×Kᵢₙₜᵣₐ×M_{groupA,i,j}) in gaps where M_{groupB,i,j}≠0, where j=0 . . . (160/MGRP)−1, and
      ii) ceil(R₁×M_{groupA,i,j}) in gaps where M_{groupB,i,j}=0, where j=0 . . . (160/MGRP)−1; and
   b) MO i is a group B MO, CSSF_{within_gap,i} is the maximum among:
      i) ceil(R₁×Kᵢₙₜₑᵣ×M_{groupBi,j}) in gaps where M_{groupA,i,j}≠0, where j=0 . . . (160/MGRP)−1, and
      ii) ceil(R₁×M_{groupB,i,j}) in gaps where M_{groupA,i,j}=0, where j=0 . . . (160/MGRP)−1.

In (A) and (B), Rᵢ is the maximal ratio of the number of MGs where MO i is a candidate to be measured over the number of MGs where MO i is a candidate and not used for a long-periodicity measurement defined above. Additionally, the “ceil” may represent a ceiling function that rounds a number up to the next whole number if it is not already an integer, and the “max” may represent a maximum function that takes a set of values as input and returns the largest value from that set.

From the measGapSharingScheme formulas (e.g., (A) and (B) above), the CSSF_{within_gap} depends on two factors: a first factor which is the number of candidates to be measured in group A or group B, and a second factor which is the ratio between two pools Kᵢₙₜᵣₐ/Kᵢₙₜₑᵣ (see e.g., equations 2.1-1 and 2.1-2 infra). How to classify/group the PCell SCC and PSCell SCC into group A and group B is as follows.

In some embodiments, a grouping scheme for FR1+FR1 NR-DC includes: if the number of configured inter-frequency and inter-RAT MOs and NR PRS measurements on all positioning frequency layers is non-zero, and the UE 102 is configured with per-UE gaps or if the UE 102 is configured with per-FR gaps, grouping or otherwise including intra-frequency MOs of FR1 PCell and FR1 PSCell to group A and grouping or otherwise including inter-frequency and inter-RAT MOs and up to one NR PRS measurement on any one positioning frequency layer to group B.

Additionally or alternatively, a grouping scheme for FR1+FR1 NR-DC includes: if the number of configured inter-frequency and inter-RAT measurement objects and NR PRS measurements on all positioning frequency layers is zero and the UE 102 is configured with per-UE gaps or per-FR gaps, grouping or otherwise including intra-frequency MOs of FR1 PCell to group A and grouping or otherwise including intra-frequency MOs of FR1 PSCell to group B.

Additionally or alternatively, a grouping scheme for FR1+FR1 NR-DC includes: if the number of configured inter-frequency and inter-RAT measurement objects and NR PRS measurements on all positioning frequency layers is zero and the UE 102 is configured with per-UE gaps, grouping or otherwise including intra-frequency MOs of FR1 PCell to one group (e.g., group A or group B) and grouping or otherwise including intra-frequency MOs of FR1 PSCell to the same group (e.g., group A or group B). Additionally or alternatively, no further classification of MOs into group A and/or group B is required (e.g., both group A and group B are put into one group).

Additionally or alternatively, a grouping scheme for FR1+FR1 NR-DC includes: if the number of configured inter-frequency and inter-RAT measurement objects and NR PRS measurements on all positioning frequency layers is zero and the UE 102 is configured with per-UE gaps, grouping or otherwise including FR1 intra-frequency MOs associated with an MCG to group A and grouping or otherwise including FR1 intra-frequency MOs associated with an SCG to group B.

Based on the above grouping schemes for FR1+FR1 NR-DC, if the number of configured inter-frequency and inter-RAT MOs and NR PRS measurements on all positioning frequency layers is zero and the UE 102 is configured with per-UE gaps: FR1 intra-frequency MOs of an MCG belong to group A; FR1 intra-frequency MOs of an SCG belong to group B; M_{groupA,i,j} is the number of FR1 intra-frequency MOs M_{intra-FR1,i,j} associated with the MCG, including both SSB-based and CSI-RS based, which are candidates to be measured in gap j where the measurement object i is also a candidate, otherwise M_{groupA,i,j} equals 0; and M_{groupBi,j} is the number of FR1 intra-frequency MOs M_{intra-FR1,i,j} associated with the SCG, including both SSB-based and CSI-RS based, which are candidates to be measured in gap j where the measurement object i is also a candidate, otherwise M_{groupB,i,j} equals 0.

Additionally or alternatively, the aforementioned grouping scheme can be modified for FR1+FR2 NR-DC as follows: FR2 intra-frequency MOs of an SCG belong to group B for FR1+FR2 NR-DC; and M_{groupBi,j} is the number of FR2 intra-frequency MOs M_{intra-FR2,i,j}, including both SSB and CSI-RS based, which are candidates to be measured in gap j where the measurement object i is also a candidate, otherwise M_{groupB,i,j} equals 0.

### 2. Cellular Network Aspects

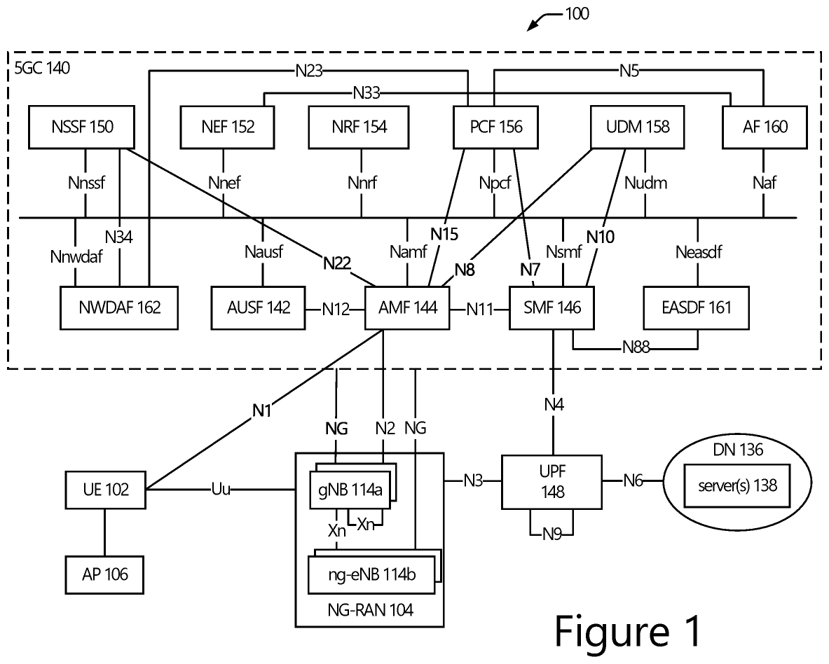

FIG. 1 depicts an example network architecture 100. The network 100 may operate in a manner consistent with 3GPP technical specifications for LTE or 5G/NR systems. However, the example embodiments are not limited in this regard and the described examples may apply to other networks that benefit from the principles described herein, such as future 3GPP systems, or the like.

The network 100 includes a UE 102, which is any mobile or non-mobile computing device designed to communicate with a RAN 104 via an over-the-air connection. The UE 102 is communicatively coupled with the RAN 104 by a Uu interface, which may be applicable to both LTE and NR systems. Examples of the UE 102 include, but are not limited to, a smartphone, tablet computer, wearable device (e.g., smart watch, fitness tracker, smart glasses, smart clothing/fabrics, head-mounted displays, smart shows, and/or the like), desktop computer, workstation, laptop computer, in-vehicle infotainment system, in-car entertainment system, instrument cluster, head-up display (HUD) device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, machine-to-machine (M2M), device-to-device (D2D), machine-type communication (MTC) device, Internet of Things (IoT) device, smart appliance, flying drone or unmanned aerial vehicle (UAV), terrestrial drone or autonomous vehicle, robot, electronic signage, single-board computer (SBC) (e.g., Raspberry Pi, Arduino, Intel Edison, and the like), plug computers, and/or any type of computing device such as any of those discussed herein.

The network 100 may include a set of UEs 102 coupled directly with one another via a D2D, ProSe, PC5, and/or sidelink (SL) interface, and/or any other suitable interface such as any of those discussed herein. In 3GPP systems, SL communication involves communication between two or more UEs 102 using 3GPP technology without traversing a network node. These UEs 102 may be M2M/D2D/MTC/IoT devices and/or vehicular systems that communicate using an SL interface, which includes, for example, one or more SL logical channels (e.g., Sidelink Broadcast Control Channel (SBCCH), Sidelink Control Channel (SCCH), and Sidelink Traffic Channel (STCH)); one or more SL transport channels (e.g., Sidelink Shared Channel (SL-SCH) and Sidelink Broadcast Channel (SL-BCH)); and one or more SL physical channels (e.g., Physical Sidelink Shared Channel (PSSCH), Physical Sidelink Control Channel (PSCCH), Physical Sidelink Feedback Channel (PSFCH), Physical Sidelink Broadcast Channel (PSBCH), and/or the like). The UE 102 may perform blind decoding attempts of SL channels/links according to the various examples herein.

The UE 102 may communicate with an AP 106 via an over-the-air (OTA) connection. The AP 106 manages a WLAN connection, which may serve to offload some/all network traffic from the RAN 104. The connection between the UE 102 and the AP 106 may be consistent with any IEEE 802.11 protocol. Additionally, the UE 102, RAN 104, and AP 106 may utilize cellular-WLAN aggregation/integration (e.g., LWA/LWIP). Cellular-WLAN aggregation may involve the UE 102 being configured by the RAN 104 to utilize both cellular radio resources and WLAN resources.

The RAN 104 includes one or more network access nodes (NANs) 114, each of which terminate air-interface(s) for the UE 102 by providing access stratum (AS) protocols including RRC, PDCP, RLC, MAC, and PHY protocols. In this manner, the NAN 114 enables data/voice connectivity between CN 140 and the UE 102. The NANs 114 may be a macrocell base station or a low power base station for providing femtocells, picocells or other like cells having smaller coverage areas, smaller user capacity, or higher bandwidth compared to macrocells; or some combination thereof. Each NAN 114 manages one or more cells, cell groups, component carriers (CCs) in carrier aggregation (CA), and the like to provide the UE 102 with an air interface for network access. The UE 102 may be simultaneously connected with a set of cells provided by the same or different NANs 114. For example, the UE 102 and RAN 104 may use CA to allow the UE 102 to connect with a set of CCs, each corresponding to a PCell, SCell, PSCell, SpCell, and/or the like. In dual connectivity (DC) scenarios, a first NAN 114 may be a master node that provides an MCG and a second NAN 114 may be secondary node that provides an SCG. The first/second NANs 114 may be any combination of eNB, gNB, ng-eNB, and the like.

The NG-RAN 104 (or individual RAN nodes 114) provide a 5G-NR air interface (Uu interface) with the following characteristics: variable subcarrier spacing (SCS); Cyclic-Prefix Orthogonal Frequency Division Multiplexing (CP-OFDM) for DL, CP-OFDM and Discrete Fourier Transform-Spread (DFT-s)-OFDM for UL; polar, repetition, simplex, and Reed-Muller codes for control and LDPC for data. The 5G/NR air interface includes physical channels and physical signals. A UL physical channel corresponds to a set of resource elements (REs) carrying information originating from higher layers. Examples of UL physical channels include physical uplink shared channel (PUSCH); physical uplink control channel (PUCCH); and physical random access channel (PRACH). A DL physical channel corresponds to a set of REs carrying information originating from higher layers. Examples of DL physical channels include physical downlink shared channel (PDSCH); physical broadcast channel (PBCH); and physical downlink control channel (PDCCH). A UL physical signal is used by the physical layer, but does not carry information originating from higher layers. Examples of UL physical signals (or reference signals (RS)) include demodulation reference signals (DMRS), phase-tracking reference signals (PTRS), and sounding reference signal (SRS). A DL physical signal corresponds to a set of resource elements used by the physical layer, but does not carry information originating from higher layers. Examples of DL physical signals (or RS) include DMRS, PTRS, positioning reference signal (PRS), channel-state information reference signal (CSI-RS), synchronization signal block (SSB), primary synchronization signal (PSS), and secondary synchronization signal (SSS). Additional or alternatively physical channels and/or physical signals can be defined and/or used. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH. The 5G-NR air interface may utilize bandwidth parts (BWPs) for various purposes, for example, dynamic adaptation of the SCS.

The NG-RAN 104 supports multi-radio DC (MR-DC) operation where a UE 102 is configured to utilize radio resources provided by two distinct schedulers, located in at least two different NG-RAN nodes 114 connected via a non-ideal backhaul, one NG-RAN node 114 providing NR access and the other NG-RAN node 114 providing either E-UTRA or NR access. One node acts as a master node (MN) and the other as a secondary node (SN), and the MN and SN are connected via a network interface and at least the MN is connected to the core network (e.g., CN 140). In some implementations, the MN and/or the SN can be operated with shared spectrum channel access. Further details of MR-DC operation, including conditional PSCell addition (CPA) and conditional PSCell change (CPC), can be found in 3GPP TS 36.300 v17.5.0 (2023 Jul. 6) (“[TS36300]”), [TS38300], and 3GPP TS 37.340 v17.5.0 (2023 Jun. 30), the contents of each of which are hereby incorporated by reference in their entireties. The NG-RAN 104 also supports layer 1 (L1) and/or layer 2 (L2) based inter-cell mobility as discussed in U.S. application Ser. No. 18/352,810 filed on Jul. 14, 2023, the contents of which is hereby incorporated by reference in its entirety.

As discussed in more detail infra, the UE 102 can be configured to perform/collect signal/cell measurements, and provide measurement reports to one or more NANs 114. The measurement reports include, for example, a measId of the associated measurement configuration that triggered the reporting; cell and/or beam measurement quantities to be included in measurement reports as configured by the network; and/or other information as discussed herein. Additionally or alternatively, each measurement report can be tagged with a timestamp and/or a location of where the measurement was performed/collected. In any of the examples discussed herein, any suitable measurement collection and/or reporting mechanism(s) may be used to collect and report measurements such as, for example, data marking, sequence numbering, packet tracing, signal measurement, data sampling, and/or timestamping techniques. The measurement collection may be based on occurrence of events that trigger collection of the data. Additionally or alternatively, measurement collection may take place at the initiation or termination of an event. The data collection can be continuous, discontinuous, and/or have start and stop times. The measurement collection and/or reporting techniques/mechanisms may be specific to a hardware (HW) configuration/implementation or non-HW-specific, and/or may be based on various SW parameters (e.g., OS type and version, radio platform, and/or the like). As examples, the measurement and reporting procedures performed by the UE 102 can include any of those discussed in 3GPP TS 38.211 v17.5.0 (2023 Jun. 26), 3GPP TS 38.212 v17.5.0 (2023 Mar. 30), 3GPP TS 38.213 v17.6.0 (2023 Jun. 26), 3GPP TS 38.214 v17.6.0 (2023 Jun. 26), [TS38215], 3GPP TS 38.101-1 v18.2.0 (2023 Jun. 30), 3GPP TS 38.104 v18.2.0 (2023 Jun. 30), and/or 3GPP TS 38.133 v18.2.0 (2023 Jun. 30), [TS38331], the contents of each of which are hereby incorporated by reference in their entireties.

Examples of the measurements to be collected and included in measurement reports can include one or more of the following: bandwidth (BW) (or channel BW), network or cell load, latency, jitter, round trip time (RTT), number of interrupts, out-of-order delivery of data packets, transmission power, bit error rate, bit error ratio (BER), Block Error Rate (BLER), packet error ratio (PER), packet loss rate, packet reception rate (PRR), data rate, peak data rate, end-to-end (e2e) delay, signal-to-noise ratio (SNR), signal-to-noise and interference ratio (SINR), signal-plus-noise-plus-distortion to noise-plus-distortion (SINAD) ratio, carrier-to-interference plus noise ratio (CINR), Additive White Gaussian Noise (AWGN), total received power density (Io) (e.g., including signal and interference, as measured at the UE antenna connector or radiated interface boundary), power spectral density (Ioc) (e.g., integrated in a noise bandwidth equal to the chip rate and normalized to the chip rate) of a band limited noise source (simulating interference from cells, which are not defined in a test procedure) as measured at the UE antenna connector or radiated interface boundary), received power spectral density of the total noise and interference for a certain RE (Iot) (e.g., power integrated over the RE and normalized to the subcarrier spacing) as measured at the UE antenna connector or radiated interface boundary), power spectral density of a white noise source (N_{oc}) (e.g., average power per RE normalised to the subcarrier spacing), simulating interference from cells that are not defined in a test procedure, as measured at the UE antenna connector or radiated interface boundary), energy per bit to noise power density ratio (E_{b}/N₀), energy per chip to interference power density ratio (E_{c}/I₀), energy per chip to noise power density ratio (E_{c}/N₀), peak-to-average power ratio (PAPR), reference signal received power (RSRP), reference signal received quality (RSRQ), received signal strength indicator (RSSI), received channel power indicator (RCPI), received signal to noise indicator (RSNI), Received Signal Code Power (RSCP), average noise plus interference (ANPI), GNSS timing of cell frames, GNSS code measurements, GNSS carrier phase measurements and/or accumulated delta range (ADR), received energy per RE (Es) (e.g., power normalized to the subcarrier spacing) during the useful part of the symbol, and in some examples, excluding the cyclic prefix, at the UE antenna connector or radiated interface boundary), timing advances, timing offsets, channel interference measurements, thermal noise power measurements, received interference power measurements, power histogram measurements, channel load measurements, station statistics, and/or any variations thereof. Additional or alternative measurements can also be collected and reported, such as any of the measurement types discussed in 3GPP TS 36.214 v17.0.0 (2022 Mar. 31), 3GPP TS 38.215 v17.3.0 (2023 Mar. 30) (“[TS38215]”), 3GPP TS 38.314 v17.3.0 (2023 Jun. 30), 3GPP TS 28.552 v18.3.0 (2023 Jun. 27) (“[TS28552]”), 3GPP TS 32.425 v17.1.0 (2021 Jun. 24) (“[TS32425]”), 3GPP TS 32.401 v17.0.0 (2022 Apr. 1), and IEEE Standard for Information Technology-Telecommunications and Information Exchange between Systems—Local and Metropolitan Area Networks-Specific Requirements—Part 11: Wireless LAN Medium Access Control (MAC) and Physical Layer (PHY) Specifications, IEEE Std 802.11-2020, pp. 1-4379 (26 Feb. 2021) (“[IEEE80211]”), the contents of each of which are hereby incorporated by reference in their entireties. Additionally or alternatively, any of the aforementioned measurements (or combination of measurements) may be collected by one or more NANs 114 and provided to the edge compute node(s), NF(s), and/or any other entity/elements discussed herein.

In some examples, the measurements are NR intra-frequency measurements. A measurement is defined as an SSB-based intra-frequency measurement provided the center frequency of the SSB of the serving cell indicated for measurement and the center frequency of the SSB of the neighbor cell are the same, and the subcarrier spacing of the two SSBs are also the same. The UE 102 is able to identify new intra-frequency cells and perform SS-RSRP, SS-RSRQ, and SS-SINR measurements of identified intra-frequency cells if carrier frequency information is provided by PCell or the PSCell, even if no explicit neighbor list with physical layer cell identities is provided. The UE 102 can perform intra-frequency SSB-based measurements with MGs or without MGs (either legacy MG or Network Controlled Small Gap (NCSG)). Additional aspects of NR intra-frequency measurements are described in [TS38133] § 9.2. In some examples, the measurements are NR inter-frequency measurements. A measurement is defined as an SSB-based inter-frequency measurement provided it is not defined as an intra-frequency measurement as discussed previously and/or according to [TS38133] § 9.2. The UE 102 is able to identify new inter-frequency cells and perform SS-RSRP, SS-RSRQ, and SS-SINR measurements of identified inter-frequency cells if carrier frequency information is provided by PCell or PSCell, even if no explicit neighbor list with physical layer cell identities is provided. The UE 102 can perform inter-frequency SSB-based measurements with MGs or without MGs (either legacy MG or NCSG) in an active BWP. Additional aspects of NR inter-frequency measurements are described in [TS38133] § 9.3.

The signal/cell measurement and reporting may be used for performing handovers (HOs) and/or conditional HOs (CHOs). An HO and/or CHO can be performed within the same RAT (or RAN 104) and/or CN 140, or it can involve a change of the RAT (or RAN 104) and/or CN 140. For performing an HO, the UE 102 receives a measurement configuration from a source cell (e.g., a cell provided by a RAN node 114), performs neighbor cell measurements according to the measurement configuration, and sends a measurement report to the network (e.g., the source cell) when the entry condition of at least one measurement event is met. Then, the source cell sends an HO command to the UE 102, and the UE 102 performs random access channel (RACH) procedure to get access to a target cell (e.g., another cell provided by the same or different RAN node 114), which includes sending a random access (RA) preamble to the target cell, and receiving an RA response from the target cell. The UE 102 then sends an HO complete message to target cell. In NR, the HO command is (or is included in) a RRCReconfiguration message in which a masterCellGroup field includes a reconfigurationWithSync field, and the HO complete message is (or is included in) an RRCReconfigurationComplete message. In CHO, to avoid late transmission (Tx) of an HO command, candidate target cells (e.g., one or more cells provided by one or more RAN nodes 114) and the corresponding execution conditions can be configured to the UE 102 in advance. When an entry condition of at least one measurement event is met (e.g., the CHO execution condition is met), the UE 102 initiates an execution of conditional reconfiguration for a target cell by performing the RACH procedure and sending an RR CReconfigurationComplete message to the target cell. Meanwhile, a set of multiple candidate target cells can be configured to the UE 102, and the UE 102 can select one of the target cells among the set of candidate target cells (e.g., more than one candidate target cells are configured) when the corresponding measurement event for this candidate cell is triggered.

The RAN nodes 114 may include a set of gNBs 114a. Each gNB 114a connects with 5G-enabled UEs 102 using a 5G-NR air interface (Uu interface) with parameters and characteristics as discussed in [TS38300], among many other 3GPP standards. The RAN nodes 114 may also include a set of ng-eNBs 114b that connect with UEs 102 via the 5G Uu and/or an LTE Uu interface. The gNBs 114a and the ng-eNBs 114b connect with the 5GC 140 through respective NG interfaces, which include an N2 interface, an N3 interface, and/or other interfaces. The gNB 114a and the ng-eNB 114b are connected with each other over an Xn interface. Additionally, individual gNBs 114a are connected to one another via respective Xn interfaces, and individual ng-eNBs 114b are connected to one another via respective Xn interfaces. The NG interface may be split into two parts, an NG user plane (NG-U) interface, which carries traffic data between the nodes of the NG-RAN 114 and a UPF 148 (e.g., N3 interface), and an NG control plane (NG-C) interface, which is a signaling interface between the nodes of the NG-RAN 114 and an AMF 144 (e.g., N2 interface). The Xn interfaces may be separated into control/user plane interfaces, which allows the NANs 114 to communicate information related to handovers (HOs), data/context transfers, mobility, load management, interference coordination, and the like.

One example NG-RAN implementation is a “CU/DU split” architecture where the NANs 114 are embodied as a gNB-Central Unit (CU) that is communicatively coupled with one or more gNB-Distributed Units (DUs), where each DU may be communicatively coupled with one or more Radio Units (RUs) (see e.g., 3GPP TS 38.300 v17.5.0 (2023 Jun. 30) (“[TS38300]”), 3GPP TS 38.401 v17.5.0 (2023 Jun. 29) (“[TS38401]”), 3GPP TS 38.410 v 17.1.0 (2022 Jun. 23), and 3GPP TS 38.473 v17.5.0 (2023 Jun. 29), the contents of each of which are incorporated by reference in their entireties). Any other type of architectures, arrangements, and/or configurations can be used. For example, in some implementations, the RAN 104, CN 140, and/or edge computing nodes (e.g., server(s) 138) can be disaggregard into various functions as discussed in U.S. application Ser. No. 17/704,658 filed on 25 Mar. 2022 (“['658]”).

The NG-RAN 104 supports NG-RAN multi-radio DC (MR-DC) operation where a UE 102 in RRC_CONNECTED is configured to utilize radio resources provided by two distinct schedulers, located in at least two different NG-RAN nodes 114 connected via a non-ideal backhaul, one NG-RAN node 114 providing NR access and the other NG-RAN node 114 providing either E-UTRA or NR access. One node acts as a master node (MN) and the other as a secondary node (SN), and the MN and SN are connected via a network interface and at least the MN is connected to the core network (e.g., CN 140). In some implementations, the MN and/or the SN can be operated with shared spectrum channel access. In particular, NG-RAN 104 supports NR-NR Dual Connectivity (NR-DC), in which a UE 102 is connected to one gNB 114a that acts as a MN and another gNB 114a that acts as a SN. In addition, NR-DC can also be used when a UE is connected to a single gNB, acting both as a MN and as a SN, and configuring both MCG and SCG. Further details of MR-DC operation, including conditional PSCell addition (CPA) and conditional PSCell change (CPC), can be found in [TS36300], [TS38300], and 3GPP TS 37.340 v17.5.0 (2023 Jun. 30) (“[TS37340]”), the contents of each of which are hereby incorporated by reference in their entireties and for all purposes. For DC at L2, when the UE 102 is configured with SCG, the UE 102 is configured with at least two MAC entities: one MAC entity for the MCG and one MAC entity for each SCG. Further details of DC operation can be found in [TS37340]. Additionally or alternatively, the UE 102 may be provided with respective measurement configurations for each cell (e.g., one measurement configuration for the MCG cell (or PCell) and a measurement configuration for each SCG (or each PSCell or SCell)).

Additionally or alternatively, the NG-RAN 104 supports carrier aggregation (CA). In CA, two or more component carriers (CCs) are aggregated. A UE 102 may simultaneously receive or transmit on one or multiple CCs depending on its capabilities. For example, a UE 102 with single timing advance (TA) capability for CA can simultaneously receive and/or transmit on multiple CCs corresponding to multiple serving cells sharing the same TA (multiple serving cells grouped in one timing advance group (TAG)); a UE 102 with multiple timing advance capability for CA can simultaneously receive and/or transmit on multiple CCs corresponding to multiple serving cells with different timing advances (multiple serving cells grouped in multiple TAGs). The NG-RAN 104 ensures that each TAG contains at least one serving cell; and a non-CA capable UE 102 can receive on a single CC and transmit on a single CC corresponding to one serving cell only (one serving cell in one TAG).

CA is supported for both contiguous and non-contiguous CCs. When CA is deployed frame timing and SFN are aligned across cells that can be aggregated, or an offset in multiples of slots between the PCell/PSCell and an SCell is configured to the UE. The maximum number of configured CCs for a UE 102 is 16 for DL and 16 for UL. CA can also involve a primary cell (PCell), primary secondary cell group (SCG) cells (PSCell), serving cells, secondary cells, and special cells. A PCell is a master cell group (MCG) cell, operating on the primary frequency, in which the UE 102 either performs the initial connection establishment procedure or initiates the connection re-establishment procedure. A PSCell, for dual connectivity operation, the SCG cell in which the UE 102 performs random access when performing the reconfiguration with sync procedure. A serving cell, for a UE 102 in RRC_CONNECTED not configured with CA/DC there is only one serving cell comprising of the primary cell. For a UE 102 in RRC_CONNECTED configured with CA/DC the term ‘serving cells’ is used to denote the set of cells comprising of the SpCell(s) and all SCells. An SCell, for a UE 102 configured with CA, is a cell providing additional radio resources on top of an SpCell. For DC operation the term SpCell refers to the PCell of an MCG or the PSCell of an SCG, otherwise the term SpCell refers to the PCell.

At layer 3 (L3) (e.g., RRC), when CA is configured, the UE 102 only has one RRC connection with the network (e.g., RAN 104 and/or RAN node 114). At RRC connection establishment/re-establishment/HO, one serving cell provides non-access stratum (NAS) mobility information, and at RRC connection re-establishment/handover, one serving cell provides the security input. This cell is referred to as the PCell. Depending on UE capabilities, one or more SCells can be configured to form together with the PCell a set of serving cells. In these implementations, the configured set of serving cells for a UE 102 includes one PCell and one or more SCells. The reconfiguration, addition, and removal of SCells can be performed by RRC. At intra-NR HO and during connection resume from RRC_INACTIVE, the network can also add, remove, keep, or reconfigure SCells for usage with the target PCell. When adding a new SCell, dedicated RRC signaling is used for sending all required system information of the SCell e.g. while in connected mode, UEs 102 need not acquire broadcast system information directly from the SCells.

At layer 2 (L2), in case of CA, the multi-carrier nature of the PHY layer is only exposed to the MAC layer for which one HARQ entity is required per serving cell. In both UL and DL, there may be one independent HARQ entity per serving cell and one transport block is generated per assignment/grant per serving cell in the absence of spatial multiplexing. Each transport block and its potential HARQ retransmissions are mapped to a single serving cell. Additional aspects are discussed in [TS38300], [TS37324], [TS38323], [TS38322], and [TS38321].

Still referring to FIG. 1, the RAN 104 is communicatively coupled to CN 140 that includes network elements and/or network functions (NFs) to provide various functions to support data and telecommunications services to customers/subscribers (e.g., UE 102). The components of the CN 140 may be implemented in one physical node or separate physical nodes. NFV may be utilized to virtualize any or all of the functions provided by the network elements of the CN 140 onto physical compute/storage resources in servers, switches, and the like. A logical instantiation of the CN 140 may be referred to as a network slice, and a logical instantiation of a portion of the CN 140 may be referred to as a network sub-slice.

In the example of FIG. 1, the CN 140 is a 5G core network (5GC) 140 including an Authentication Server Function (AUSF) 142, Access and Mobility Management Function (AMF) 144, Session Management Function (SMF) 146, User Plane Function (UPF) 148, Network Slice Selection Function (NSSF) 150, Network Exposure Function (NEF) 152, Network Repository Function (NRF) 154, Policy Control Function (PCF) 156, Unified Data Management (UDM) 158, Application Function (AF) 160, Edge Application Server Discovery Function (EASDF) 161, and Network Data Analytics Function (NWDAF) 162 coupled with one another over various interfaces as shown. The NFs in the 5GC 140 are described infra and in [TS23501], [TS23502], [TS23503], among many other 3GPP standards.

The NWDAF 162 includes one or more of the following functionalities: support data collection from NFs and AFs 160; support data collection from OAM 240; NWDAF service registration and metadata exposure to NFs and AFs 160; support analytics information provisioning to NFs and AFs 160; support machine learning (ML) model training and provisioning to NWDAF(s) 162. Some or all of the NWDAF functionalities can be supported in a single instance of an NWDAF 162. The NWDAF 162 includes an analytics reporting capability (e.g., an analytics logical function (AnLF)) comprising means that allow discovery of the type of analytics that can be consumed by an external party and/or the request for consumption of analytics information generated by the NWDAF 162. The NWDAF 162 may contain an AnLF and/or a model training logical function (MTLF). Additional aspects of NWDAF 162 functionality are defined in 3GPP TS 23.288 v18.2.0 (2023 Jun. 21) (“[TS23288]”).

The AUSF 142 stores data for authentication of UE 102 and handle authentication-related functionality. The AUSF 142 may facilitate a common authentication framework for various access types.

The AMF 144 allows other functions of the 5GC 140 to communicate with the UE 102 and the RAN 104 and to subscribe to notifications about mobility events w.r.t the UE 102. The AMF 144 includes the following functionality, some or all which may be supported in a single instance of an AMF 144: termination of RAN CP interface (N2); termination of NAS (N1), NAS ciphering and integrity protection; registration management; connection management; reachability management; mobility management; lawful intercept (for AMF events and interface to LI System); provide transport for session management (SM) messages between UE 102 and SMF 146; transparent proxy for routing SM messages; access authentication; access authorization; provide transport for short message service (SMS) messages between UE 102 and SMS function (SMSF); security anchor functionality (SEAF) as specified in 3GPP TS 33.501 (“[TS33501]”); location services management for regulatory services; provide transport for location services messages between the UE 102 and location management function (LMF) and between the RAN 104 and the LMF; EPS Bearer ID allocation for interworking with EPS; UE mobility event notification; S-NSSAIs per TA mapping notification; support for Control Plane CIoT 5GS optimization; support for User Plane CIoT 5GS optimization; support for restriction of use of enhanced coverage; provisioning of external parameters (expected UE behavior parameters or Network Configuration parameters); support for Network Slice-Specific Authentication and Authorization; support for charging; controlling the 5G access stratum-based time distribution based on UE's subscription data; and/or controlling the gNB's time synchronization status reporting and subscription. In addition to the aforementioned functionalities of the AMF 144, the AMF 144 may include policy related functionalities as described in clause 6.2.8 of

The SMF 146 includes the following functionality, some or all of which may be supported in a single instance of a SMF 146: SM including, for example, session establishment, modify, and release, including tunnel maintain between UPF 148 and (R)AN node 114 (SM refers to management of a PDU session, and a PDU session or “session” refers to a PDU connectivity service that provides or enables the exchange of PDUs between the UE 102 and the DN 136); UE internet protocol (IP) address allocation & management (including optional Authorization). The UE IP address may be received from a UPF or from an external data network; server and client functions in Dynamic Host Configuration Protocol (DHCP) version 4 (DHCPv4) and/or and DHCPv6; functionality to respond to address resolution protocol (ARP) requests and/or IP version 6 (IPv6) neighbor solicitation requests based on local cache information for the Ethernet PDUs (the SMF 146 responds to the ARP and/or the IPv6 neighbor solicitation request by providing the MAC address corresponding to the IP address sent in the request; selection and control of UP function, including controlling the UPF to proxy ARP or IPv6 Neighbor Discovery, or to forward all ARP/IPv6 Neighbor Solicitation traffic to the SMF, for Ethernet PDU sessions; configures traffic steering at UPF to route traffic to proper destination; 5G virtual network (VN) group management, e.g. maintain the topology of the involved PSA UPFs, establish and release the N19 tunnels between PSA UPFs, configure traffic forwarding at UPF to apply local switching, N6-based forwarding or N19-based forwarding, manage traffic forwarding in the case that a SMF Set or multiple SMF Sets are serving a 5G VN; termination of interfaces towards Policy control functions; lawful intercept (for SM events and interface to LI system); support for charging; control and coordination of charging data collection at UPF 148; termination of SM parts of NAS messages; DL data notification; initiator of (R)AN specific SM information, sent via AMF 144 over N2 to (R)AN 104; determine session and service continuity (SSC) mode of a session; support for control plane CIoT 5GS optimization; support of header compression; act as I-SMF in deployments where I-SMF can be inserted, removed and relocated; provisioning of external parameters (Expected UE Behavior parameters or Network Configuration parameters); support P-CSCF discovery for IMS services; act as V-SMF with following roaming functionalities: handle local enforcement to apply QoS SLAs (VPLMN), charging (VPLMN), and lawful intercept (in VPLMN for SM events and interface to LI System); support for interaction with external DN 136 for transport of signaling for PDU session authentication/authorization by external DN 136; instructs UPF 148 and NG-RAN 104 to perform redundant transmission on N3/N9 interfaces; generation of the time sensitive communication (TSC) assistance information based on the TSC assistance container received from the PCF 156; support for RAN feedback for BAT offset and adjusted periodicity as defined in clause 5.27.2.5 of [TS23501]; and/or support edge computing enhancements as discussed in [TS23548], [TS23558], and [TS23501] § 6.3.23. In addition to the aforementioned functionalities, the SMF 146 may include policy related functionalities as described in clause 6.2.2 of [TS23503].

The UPF 148 acts as an anchor point for intra-RAT and inter-RAT mobility, an external PDU session point of interconnect to DN 136, and a branching point to support multi-homed PDU session. PDU connectivity service and PDU session aspects are discussed in 3GPP TS 38.415 v17.0.0 (2022 Apr. 6) and 3GPP TS 38.413 v17.3.0 (2023 Jan. 6). The UPF 148 also performs packet routing and forwarding, packet inspection, enforces user plane part of policy rules, lawfully intercept packets (UP collection), performs traffic usage reporting, perform QoS handling for a user plane (e.g., packet filtering, gating, UL/DL rate enforcement), performs UL traffic verification (e.g., SDF-to-QoS flow mapping), transport level packet marking in the UL and DL, and performs DL packet buffering and DL data notification triggering. UPF 148 may include an UL classifier to support routing traffic flows to a data network.

The NSSF 150 selects a set of network slice instances serving the UE 102. The NSSF 150 also determines allowed NSSAI and the mapping to the subscribed S-NSSAIs, if needed. The NSSF 150 also determines an AMF set to be used to serve the UE 102, or a list of candidate AMFs 144 based on a suitable configuration and possibly by querying the NRF 154. The selection of a set of network slice instances for the UE 102 may be triggered by the AMF 144 with which the UE 102 is registered by interacting with the NSSF 150; this may lead to a change of AMF 144. The NSSF 150 interacts with the AMF 144 via an N22 reference point; and may communicate with another NSSF in a visited network via an N31 reference point (not shown).

The NEF 152 securely exposes services and capabilities provided by 3GPP NFs for third party, internal exposure/re-exposure, AFs 160, edge computing networks/frameworks, and the like. In such examples, the NEF 152 may authenticate, authorize, or throttle the AFs 160. The NEF 152 stores/retrieves information as structured data using the Nudr interface to a Unified Data Repository (UDR). The NEF 152 also translates information exchanged with the AF 160 and information exchanged with internal NFs. For example, the NEF 152 may translate between an AF-Service-Identifier and an internal 5GC information, such as DNN, S-NSSAI, as described in clause 5.6.7 of [TS23501]. In particular, the NEF 152 handles masking of network and user sensitive information to external AF's 160 according to the network policy. The NEF 152 also receives information from other NFs based on exposed capabilities of other NFs. This information may be stored at the NEF 152 as structured data, or at a data storage NF using standardized interfaces. The stored information can then be re-exposed by the NEF 152 to other NFs and AFs, or used for other purposes such as analytics. For example, NWDAF analytics may be securely exposed by the NEF 152 for external party, as specified in [TS23288]. Furthermore, data provided by an external party may be collected by the NWDAF 162 via the NEF 152 for analytics generation purpose. The NEF 152 handles and forwards requests and notifications between the NWDAF 162 and AF(s) 160, as specified in [TS23288].

The NRF 154 supports service discovery functions, receives NF discovery requests from NF instances, and provides information of the discovered NF instances to the requesting NF instances. The NRF 154 also maintains NF profiles of available NF instances and their supported services. The NF profile of NF instance maintained in the NRF 154 includes the various information discussed in [TS23501], [TS23502], [TS23288], 3GPP TS 29.510 v18.3.0 (2023 Jun. 26), 3GPP TS 23.287 v18.0.0 (2023 Mar. 31), 3GPP TS 23.247 v18.2.0 (2023 Jun. 21), and/or the like.

The PCF 156 provides policy rules to control plane functions to enforce them, and may also support unified policy framework to govern network behavior. The PCF 156 may also implement a front end to access subscription information relevant for policy decisions in a UDR of the UDM 158. In addition to communicating with functions over reference points as shown, the PCF 156 exhibit an Npcf service-based interface.

The UDM 158 handles subscription-related information to support the network entities' handling of communication sessions, and stores subscription data of UE 102. For example, subscription data may be communicated via an N8 reference point between the UDM 158 and the AMF 144. The UDM 158 may include two parts, an application front end and a UDR. The UDR may store subscription data and policy data for the UDM 158 and the PCF 156, and/or structured data for exposure and application data (including PFDs for application detection, application request information for multiple UEs 102) for the NEF 152. The Nudr service-based interface may be exhibited by the UDR to allow the UDM 158, PCF 156, and NEF 152 to access a particular set of the stored data, as well as to read, update (e.g., add, modify), delete, and subscribe to notification of relevant data changes in the UDR. The UDM 158 may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 158 may exhibit the Nudm service-based interface.

EASDF 161 exhibits an Neasdf service-based interface, and is connected to the SMF 146 via an N88 interface. One or multiple EASDF instances may be deployed within a PLMN, and interactions between 5GC NF(s) and the EASDF 161 take place within a PLMN. The EASDF 161 includes one or more of the following functionalities: registering to NRF 154 for EASDF 161 discovery and selection; handling the DNS messages according to the instruction from the SMF 146; and/or terminating DNS security, if used. Handling the DNS messages according to the instruction from the SMF 146 includes one or more of the following functionalities: receiving DNS message handling rules and/or BaselineDNSPattern from the SMF 146; exchanging DNS messages from/with the UE 102; forwarding DNS messages to C-DNS or L-DNS for DNS query; adding EDNS client subnet (ECS) option into DNS query for an FQDN; reporting to the SMF 146 the information related to the received DNS messages; and/or buffering/discarding DNS messages from the UE 102 or DNS Server. The EASDF has direct user plane connectivity (e.g., without any NAT) with the PSA UPF over N6 for the transmission of DNS signaling exchanged with the UE. The deployment of a NAT between EASDF 161 and PSA UPF 148 may or may not be supported. Additional aspects of the EASDF 161 are discussed in [TS23548].

AF 160 provides application influence on traffic routing, provide access to NEF 152, and interact with the policy framework for policy control. The AF 160 may influence UPF 148 (re)selection and traffic routing. Based on operator deployment, when AF 160 is considered to be a trusted entity, the network operator may permit AF 160 to interact directly with relevant NFs. In some implementations, the AF 160 is used for edge computing implementations. An NF that needs to collect data from an AF 160 may subscribe/unsubscribe to notifications regarding data collected from an AF 160, either directly from the AF 160 or via NEF 152.

The 5GC 140 may enable edge computing by selecting operator/3rd party services to be geographically close to a point that the UE 102 is attached to the network. This may reduce latency and load on the network. In edge computing implementations, the 5GC 140 may select a UPF 148 close to the UE yx02 and execute traffic steering from the UPF 148 to DN 136 via the N6 interface. This may be based on the UE subscription data, UE location, and information provided by the AF 160, which allows the AF 160 to influence UPF (re)selection and traffic routing.

The data network (DN) 136 is a network hosting data-centric services such as, for example, operator services, the internet, third-party services, and/or enterprise networks. The DN 136 may represent various network operator services, Internet access, or third party services that may be provided by one or more servers 138. As examples, the server(s) 138 can be or include application (app) server(s), content server(s), web server(s), database server(s), edge compute node(s) or edge server(s), DNS server(s), cloud compute node(s) or cloud compute resource(s), and/or the like. The DN 136 may be an operator external public, a private PDN, or an intra-operator packet data network, for example, for provision of IMS services. In some implementations, the DN 136 may represent one or more local area DNs (LADNs), which are DNs 136 (or DN names (DNNs)) that is/are accessible by a UE 102 in one or more specific areas, which provides connectivity to a specific DNN, and whose availability is provided to the UE 102. Outside of these specific areas, the UE 102 is not able to access the LADN/DN 1336.

Additionally or alternatively, the DN 136 may be an edge DN 136, which is a (local) DN that supports the architecture for enabling edge applications. In these examples, the server(s) 138 represent physical hardware systems/devices providing app server functionality and/or the app software resident in the cloud or at edge compute node(s) that performs server function(s). The server(s) 138 provides an edge hosting environment (or an edge computing platform) that provides support for implementing or operating edge app execution and/or for providing one or more edge services. The 5GS 100 can use one or more edge compute nodes to provide an interface and offload processing of wireless communication traffic. In these examples, the edge compute nodes may be included in, or co-located with one or more RANs 104 or RAN nodes 114. For example, the edge compute nodes can provide a connection between the RAN 104 and UPF 148 in the 5GC 140. The edge compute nodes can use one or more NFV instances instantiated on virtualization infrastructure within the edge compute nodes to process wireless connections to and from the RAN 114 and UPF 148.

An edge computing network (or collection of edge compute nodes) provide a distributed computing environment for application and service hosting, and also provide storage and processing resources so that data and/or content can be processed in close proximity to subscribers (e.g., users of UEs 102) for faster response times. The edge network also supports multitenancy run-time and hosting environment(s) for applications, including virtual appliance applications that may be delivered as packaged virtual machine (VM) images, virtualization containers, middleware application and infrastructure services, content delivery services including content caching, mobile big data analytics, and computational offloading, among others. The edge network employs one or more edge computing technologies (ECTs) (also referred to as an “edge computing framework” or the like), and includes a collection of edge compute nodes (or edge servers) and edge management systems to run edge applications (apps) within an operator network or a subset of an operator network. Each edge compute node includes an edge platform and/or virtualization infrastructure, and provide compute, storage, and network resources to edge apps. Each edge compute node is disposed at an edge of a corresponding access network (e.g., RAN 104), and are arranged to provide computing resources and/or various services (e.g., computational task and/or workload offloading, cloud-computing capabilities, IT services, and other like resources and/or services as discussed herein) in relatively close proximity to UEs 102. The VI of the edge compute nodes provide virtualized environments and virtualized resources for the edge hosts, and the edge computing applications may run as VMs and/or application containers on top of the VI. Examples of the ECT includes the MEC framework (see e.g., ETSI GS MEC 003 v3.1.1 (2022 March)), Open RAN (O-RAN) (see e.g., O-RAN Working Group 1 (Use Cases and Overall Architecture): O-RAN Architecture Description, O-RAN ALLIANCE WG1, O-RAN Architecture Description v09.00, Release R003 (June 2023)), Multi-Access Management Services (MAMS) framework (see e.g., Kanugovi et al., Multi-Access Management Services (MAMS), INTERNET ENGINEERING TASK FORCE (IETF), Request for Comments (RFC) 8743 (March 2020)), and/or 3GPP System Architecture for enabling Edge Applications (see e.g., 3GPP TS 23.558 v18.3.0 (2023 Jun. 21) (“[TS23558]”), 3GPP TS 23.501 v18.2.1 (2023 Jun. 29) (“[TS23501]”), 3GPP TS 23.502 v18.2.0 (2023 Jun. 29) (“[TS23502]”), 3GPP TS 23.548 v18.2.0 (2023 Jun. 22) (“[TS23548]”), 3GPP TS 28.538 v18.3.0 (2023 Jun. 22), 3GPP TR 23.700-98 v18.1.0 (2023 Mar. 31), 3GPP TS 23.222 v18.2.0 (2023 Jun. 21), 3GPP TS 33.122 v18.0.0 (2023 Jun. 22), 3GPP TS 29.222 v18.2.0 (2023 Jun. 26), 3GPP TS 29.522 v18.2.0 (2023 Jun. 27), 3GPP TS 29.122 v18.2.0 (2023 Jun. 26), 3GPP TS 23.682 v18.0.0 (2023 Mar. 31), 3GPP TS 23.434 v18.5.0 (2023 Jun. 21), 3GPP TS 23.401 v18.2.0 (2023 Jun. 21), 3GPP TS 28.532 v17.5.2 (2023 Jul. 5), 3GPP TS 28.533 v17.3.0 (2023 Mar. 30) (“[TS28533]”), 3GPP TS 28.535 v17.7.0 (2023 Jun. 22) (“[TS28535]”), 3GPP TS 28.536 v17.5.0 (2023 Mar. 30) (“[TS28536]”), 3GPP TS 28.541 v18.4.1 (2023 Jun. 30), 3GPP TS 28.545 v17.0.0 (2021 Jun. 24), 3GPP TS 28.550 v18.1.0 (2023 Mar. 30) (“[TS28550]”), 3GPP TS 28.554 v18.2.0 (2023 Jun. 22) (“[TS28554]”), and 3GPP TS 28.622 v18.3.0 (2023 Jun. 22) (“[TS28622]”) (collectively referred to herein as “[3GPPEdge]”), the contents of each of which are hereby incorporated by reference in their entireties). It should be understood that the aforementioned edge computing frameworks/ECTs and services deployment examples are only illustrative examples of ECTs, and that the present disclosure may be applicable to many other or additional edge computing/networking technologies in various combinations and layouts of devices located at the edge of a network including the various edge computing networks/systems described herein. Further, the techniques disclosed herein may relate to other IoT edge network systems and configurations, and other intermediate processing entities and architectures may also be applicable to the present disclosure. Examples of such edge computing/networking technologies Further, the techniques disclosed herein may relate to other IoT edge network systems and configurations, and other intermediate processing entities and architectures may also be used for purposes of the present disclosure.

The interfaces of the 5GC 140 include reference points and service-based interfaces. The reference points include: N1 (between the UE 102 and the AMF 144), N2 (between RAN 114 and AMF 144), N3 (between RAN 114 and UPF 148), N4 (between the SMF 146 and UPF 148), N5 (between PCF 156 and AF 160), N6 (between UPF 148 and DN 136), N7 (between SMF 146 and PCF 156), N8 (between UDM 158 and AMF 144), N9 (between two UPFs 148), N10 (between the UDM 158 and the SMF 146), N11 (between the AMF 144 and the SMF 146), N12 (between AUSF 142 and AMF 144), N13 (between AUSF 142 and UDM 158), N14 (between two AMFs 144; not shown), N15 (between PCF 156 and AMF 144 in case of a non-roaming scenario, or between the PCF 156 in a visited network and AMF 144 in case of a roaming scenario), N16 (between two SMFs 146; not shown), and N22 (between AMF 144 and NSSF 150). Other reference point representations not shown in FIG. 1 can also be used. The service-based representation of FIG. 1 represents NFs within the control plane that enable other authorized NFs to access their services. The service-based interfaces (SBIs) include: Namf (SBI exhibited by AMF 144), Nsmf (SBI exhibited by SMF 146), Nnef (SBI exhibited by NEF 152), Npcf (SBI exhibited by PCF 156), Nudm (SBI exhibited by the UDM 158), Naf (SBI exhibited by AF 160), Nnrf (SBI exhibited by NRF 154), Nnssf (SBI exhibited by NSSF 150), Nausf (SBI exhibited by AUSF 142). Other service-based interfaces (e.g., Nudr, N5g-eir, and Nudsf) not shown in FIG. 1 can also be used. The NEF 152 can provide an interface to edge compute nodes, which can be used to process wireless connections with the RAN 114.

Although not shown by FIG. 1, the system 100 may also include NFs that are not shown such as, for example, UDR, Unstructured Data Storage Function (UDSF), Network Slice Admission Control Function (NSACF), Network Slice-specific and Stand-alone Non-Public Network (SNPN) Authentication and Authorization Function (NSSAAF), UE radio Capability Management Function (UCMF), 5G-Equipment Identity Register (5G-EIR), CHarging Function (CHF), Time Sensitive Networking (TSN) AF 160, Time Sensitive Communication and Time Synchronization Function (TSCTSF), Data Collection Coordination Function (DCCF), Analytics Data Repository Function (ADRF), Messaging Framework Adaptor Function (MFAF), Binding Support Function (BSF), Non-Seamless WLAN Offload Function (NSWOF), Service Communication Proxy (SCP), Security Edge Protection Proxy (SEPP), Non-3GPP InterWorking Function (N3IWF), Trusted Non-3GPP Gateway Function (TNGF), Wireline Access Gateway Function (W-AGF), and/or Trusted WLAN Interworking Function (TWIF) as discussed in [TS23501].

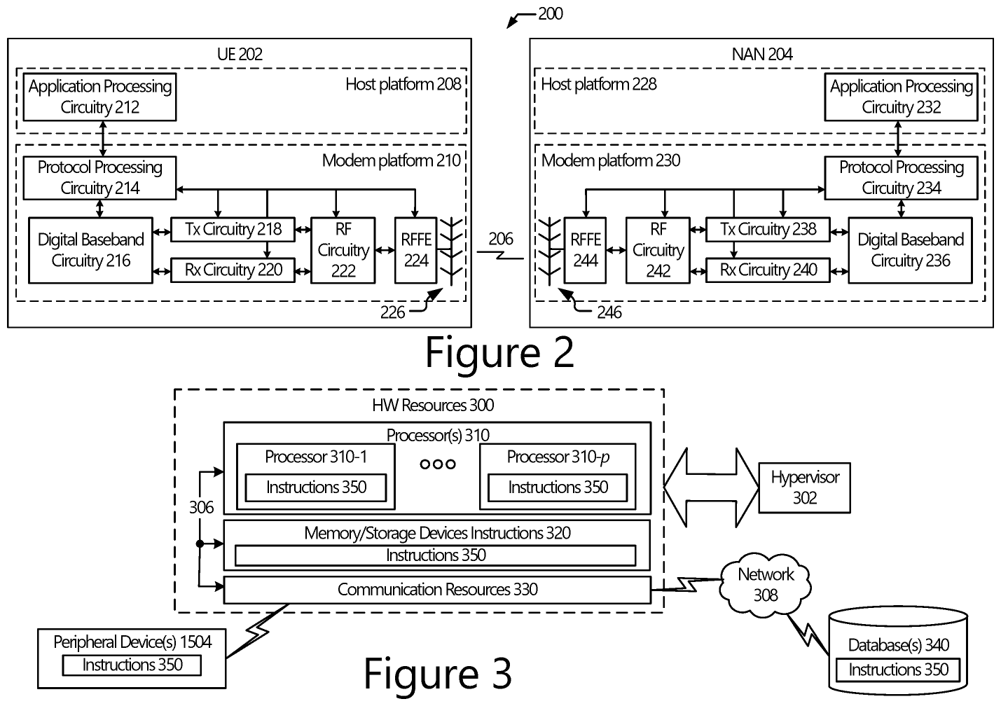

FIG. 2 illustrates a wireless network 200 that includes a UE 202 communicatively coupled with a NAN 204 via connection 206. The UE 202 and NAN 204 may be the same or similar as the UE 102 and NAN 104, respectively. The connection 206 is an air interface to enable communicative coupling, which is consistent with cellular communications protocols, such as LTE, a 5G/NR operating at mmWave or sub-6 GHz frequencies, and/or according to any other RAT discussed herein.

The UE 202 includes a host platform 208 coupled with a modem platform 210. The host platform 208 includes application processing circuitry 212, which is coupled with protocol processing circuitry 214 of the modem platform 210. The application processing circuitry 212 runs various applications for the UE 202 that source/sink application data. The application processing circuitry 212 implements one or more layer operations to transmit/receive application data to/from a data network. These layer operations include transport (e.g., UDP, TCP, QUIC, and/or the like), network (e.g., IP, and/or the like), and/or operations of other layers. The protocol processing circuitry 214 implements one or more of layer operations to facilitate transmission or reception of data over the connection 206. The layer operations implemented by the protocol processing circuitry 214 includes, for example, MAC, RLC, PDCP, RRC and NAS operations.

The modem platform 210 includes digital baseband circuitry 216 that implements one or more layer operations that are “below” layer operations performed by the protocol processing circuitry 214 in a network protocol stack. These operations includes, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which includes one or more of space-time, space-frequency or spatial coding, reference signal generation/detection, preamble sequence generation and/or decoding, synchronization sequence generation/detection, control channel signal blind decoding, and other related functions.

The modem platform 210 includes transmit (Tx) circuitry 218, receive (Rx) circuitry 220, radiofrequency (RF) circuitry 222, and an RF front end (RFFE) 224, which includes or connects to one or more antenna panels 226. The Tx circuitry 218 includes a digital-to-analog converter, mixer, intermediate frequency (IF) components, and/or the like; the Rx circuitry 220 includes an analog-to-digital converter, mixer, IF components, and/or the like; the RF circuitry 222 includes a low-noise amplifier, a power amplifier, power tracking components, and/or the like; the RFFE 224 includes filters (e.g., surface/bulk acoustic wave filters), switches, antenna tuners, beamforming components (e.g., phase-array antenna components), and/or the like; and the antenna panels 226 (also referred to as “Tx/Rx components”) include one or more antenna elements, such as planar inverted-F antennas (PIFAs), monopole antennas, dipole antennas, loop antennas, patch antennas, Yagi antennas, parabolic dish antennas, omni-directional antennas, and/or the like. The selection and arrangement of the components of the Tx circuitry 218, Rx circuitry 220, RF circuitry 222, RFFE 224, and antenna panels 226 may be specific to details of a specific implementation such as, for example, whether communication is TDM or FDM, in mmWave or sub-6 GHz frequencies, and/or the like. The Tx/Rx components may be arranged in multiple parallel Tx/Rx chains, may be disposed in the same or different chips/modules, and/or the like. The protocol processing circuitry 214 includes one or more instances of control circuitry (not shown) to provide control functions for the Tx/Rx components.

A UE reception is established by and via the antenna panels 226, RFFE 224, RF circuitry 222, Rx circuitry 220, digital baseband circuitry 216, and protocol processing circuitry 214. The antenna panels 226 may receive a transmission from the NAN 204 by receive-beamforming signals received by a set of antennas/antenna elements of the antenna panels 226. A UE transmission is established by and via the protocol processing circuitry 214, digital baseband circuitry 216, Tx circuitry 218, RF circuitry 222, RFFE 224, and antenna panels 226. The Tx components of the UE 204 may apply a spatial filter to the data to be transmitted to form a Tx beam emitted by the antenna elements of the antenna panels 226.

Similar to the UE 202, the NAN 204 includes a host platform 228 coupled with a modem platform 230. The host platform 228 includes application processing circuitry 232 coupled with protocol processing circuitry 234 of the modem platform 230. The modem platform may further include digital baseband circuitry 236, Tx circuitry 238, Rx circuitry 240, RF circuitry 242, RFFE circuitry 244, and antenna panels 246. The components of the NAN 204 may be similar to and substantially interchangeable with like-named components of the UE 202. In addition to performing data transmission/reception as described previously, the components of the NAN 208 may perform various logical functions that include, for example, RNC functions such as radio bearer management, uplink and downlink dynamic radio resource management, data packet scheduling, and/or various other functions, such as any of those discussed herein.

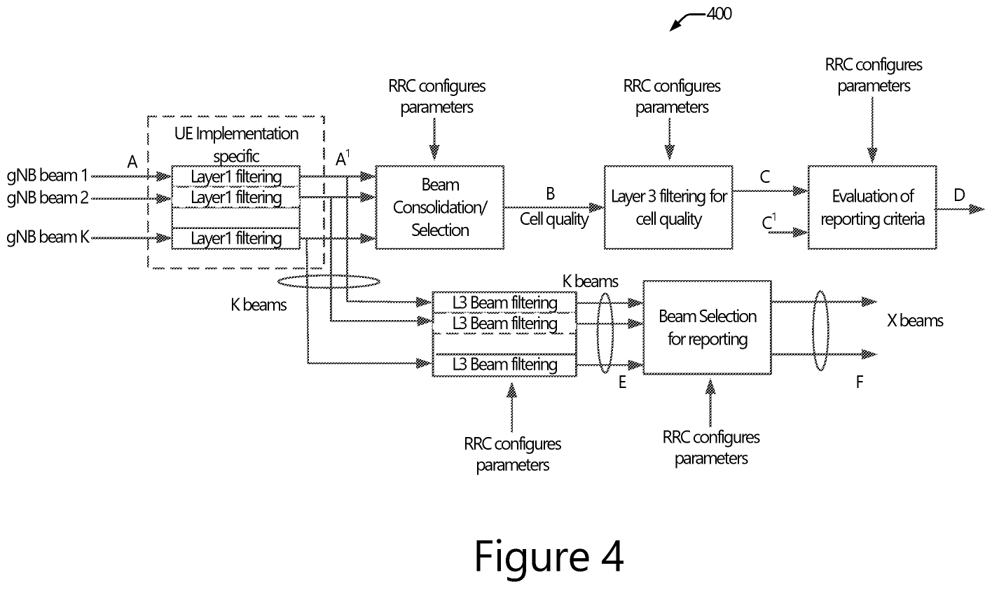

FIG. 3 illustrates hardware resources 300 capable of reading instructions from a machine-readable or computer-readable medium (e.g., a non-transitory machine-readable storage medium) and perform any one or more of the methodologies discussed herein. The hardware resources 300 may correspond to any of the entities/elements discussed herein, such as UEs 102, 202; NANs 114, 204; and/or any of the NFs discussed w.r.t FIGS. 1-2. The hardware resources 300 include one or more processors (or processor cores) 310, one or more memory/storage devices 320, and one or more communication resources 330, each of which may be communicatively coupled via a interconnect (IX) 306 or other interface circuitry, which implement any suitable bus and/or IX technologies. Where node virtualization (e.g., NFV) is utilized, a hypervisor 302 may be executed to provide an execution environment for one or more network slices/sub-slices to utilize the hardware resources 300. The hardware resources 300 may be implemented in or by an individual compute node, which may be housed in an enclosure of various form factors. Additionally or alternatively, the hardware resources 300 may be implemented by multiple compute nodes that may be deployed in one or more data centers and/or distributed across one or more geographic regions.

The processors 310 include, for example, a processor 310-1 to 310-p (where p is a number). The processors 310 may be or include, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), a microprocessor or controller, a multi-core processor, a multithreaded processor, an ultra-low voltage processor, an embedded processor, an xPU, a data processing unit (DPU), an Infrastructure Processing Unit (IPU), a network processing unit (NPU), another processor (including any of those discussed herein), and/or any suitable combination thereof.

The memory/storage devices 320 include, for example, main memory, disk storage, or any suitable combination thereof. The memory/storage devices 320 may include, but are not limited to, any type of volatile, non-volatile, semi-volatile memory, and/or any combination thereof. As examples, the memory/storage devices 320 can be or include random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, dual inline memory modules (DIMMs), microDIMMs, MiniDIMMs, block addressable memory device(s) (e.g., those based on NAND or NOR technologies (e.g., single-level cell (SLC), Multi-Level Cell (MLC), Quad-Level Cell (QLC), Tri-Level Cell (TLC), or some other NAND), read-only memory (ROM), programmable ROM (PROM), erasable PROM (EPROM), electrically EPROM (EEPROM), flash memory, non-volatile RAM (NVRAM), solid-state storage, magnetic disk storage mediums, optical storage mediums, memory devices that use chalcogenide glass, multi-threshold level NAND flash memory, NOR flash memory, single or multi-level Phase Change Memory (PCM) and/or phase change memory with a switch (PCMS), NVM devices that use chalcogenide phase change material (e.g., chalcogenide glass), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, and/or a combination of any of the aforementioned memory devices, and/or other memory.

The communication resources 330 include, for example, interconnection controllers and/or network interface controllers, components, or other suitable devices to communicate with one or more peripheral devices 304, one or more databases 340, and/or other network elements via a network 308. The network 308 may represent any suitable network (e.g., DN 136, the Internet, an enterprise network, WAN, LAN, WLAN, VN, VPN, and/or the like), an edge computing network, a cloud computing service, and/or the like. For example, the communication resources 330 can include wired communication components (e.g., for coupling via USB, Ethernet, and/or the like), cellular communication components, NFC components, Bluetooth® (or Bluetooth® Low Energy) components, WiFi® components, and other communication components.

Instructions 350 comprise software, program code, application(s), applet(s), an app(s), firmware, microcode, machine code, and/or other executable code for causing at least any of the processors 310 to perform any one or more of the methodologies and/or techniques discussed herein. The instructions 350 may reside, completely or partially, within at least one of the processors 310 (e.g., within the processor's cache memory), the memory/storage devices 320, or any suitable combination thereof. Any portion of the instructions 350 may be transferred to the hardware resources 300 from any combination of the peripheral devices 304 and/or the databases 340. Accordingly, the memory of processors 310, the memory/storage devices 320, the peripheral devices 304, and the databases 340 are examples of computer-readable and machine-readable media.

In some implementations, the peripheral devices 304 may represent one or more sensors (also referred to as “sensor circuitry”). The sensor circuitry includes devices, modules, or subsystems whose purpose is to detect events or changes in its environment and send the information (sensor data) about the detected events to some other a device, module, subsystem, and/or the like. Individual sensors may be exteroceptive sensors (e.g., sensors that capture and/or measure environmental phenomena and/external states), proprioceptive sensors (e.g., sensors that capture and/or measure internal states of a compute node or platform and/or individual components of a compute node or platform), and/or exproprioceptive sensors (e.g., sensors that capture, measure, or correlate internal states and external states). Examples of such sensors include, inter alia, inertia measurement units (IMU) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors, including sensors for measuring the temperature of internal components and sensors for measuring temperature external to the compute node or platform); pressure sensors; barometric pressure sensors; gravimeters; altimeters; image capture devices (e.g., cameras); light detection and ranging (LiDAR) sensors; proximity sensors (e.g., infrared radiation detector and the like); depth sensors, ambient light sensors; optical light sensors; ultrasonic transceivers; microphones; and the like.

Additionally or alternatively, the peripheral devices 304 may represent one or more actuators, which allow a compute node, platform, machine, device, mechanism, system, or other object to change its state, position, and/or orientation, or move or control a compute node (e.g., node 300), platform, machine, device, mechanism, system, or other object. The actuators comprise electrical and/or mechanical devices for moving or controlling a mechanism or system, and converts energy (e.g., electric current or moving air and/or liquid) into some kind of motion. As examples, the actuators can be or include any number and combination of the following: soft actuators (e.g., actuators that changes its shape in response to a stimuli such as, for example, mechanical, thermal, magnetic, and/or electrical stimuli), hydraulic actuators, pneumatic actuators, mechanical actuators, electromechanical actuators (EMAs), microelectromechanical actuators, electrohydraulic actuators, linear actuators, linear motors, rotary motors, DC motors, stepper motors, servomechanisms, electromechanical switches, electromechanical relays (EMRs), power switches, valve actuators, piezoelectric actuators and/or biomorphs, thermal biomorphs, solid state actuators, solid state relays (SSRs), shape-memory alloy-based actuators, electroactive polymer-based actuators, relay driver integrated circuits (ICs), solenoids, impactive actuators/mechanisms (e.g., jaws, claws, tweezers, clamps, hooks, mechanical fingers, humaniform dexterous robotic hands, and/or other gripper mechanisms that physically grasp by direct impact upon an object), propulsion actuators/mechanisms, projectile actuators/mechanisms, and/or audible sound generators, visual warning devices, and/or other like electromechanical components. The compute node 300 may be configured to operate one or more actuators based on one or more captured events, instructions, control signals, and/or configurations received from a service provider, client device, and/or other components of a compute node or platform. Additionally or alternatively, the actuators are used to change the operational state, position, and/or orientation of the sensors.

### 2.1. Measurement Aspects

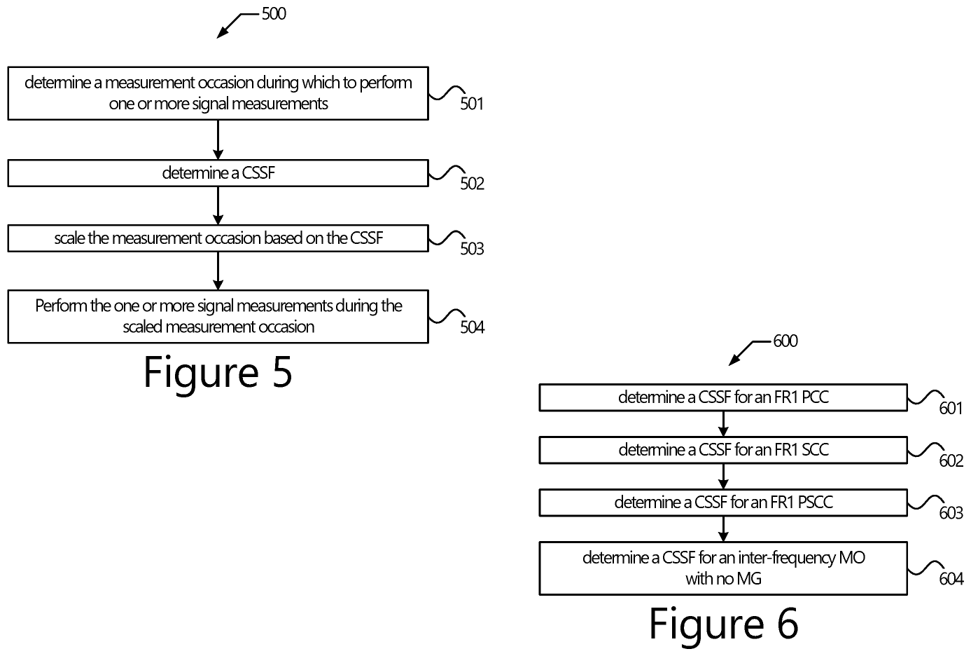

As mentioned previously, the UE 102 can be configured to perform signal/cell measurement and reporting procedures to provide the network with information about the quality of one or more wireless channels and/or the communication media in general, and this information can be used to optimize various aspects of the communication system. For example, the network (e.g., RAN 104 and/or a RAN node 114) may configure a UE 102 in RRC_CONNECTED mode (e.g., using a measurement configuration (measConfig)) to perform measurements, which may be performed according to the measurement model 400 of FIG. 4. The network may configure the UE 102 to report them in accordance with the measurement configuration or perform conditional reconfiguration evaluation in accordance with the conditional reconfiguration. The measurement configuration is provided by means of dedicated signaling, for example, using the RRCReconfiguration or RRCResume messages. The network may configure the UE 102 to perform the following types of measurements: intra-frequency NR measurements; inter-frequency NR measurements; inter-RAT measurements for E-UTRA; and inter-RAT measurements for UTRA (e.g., UTRA-FDD frequencies); NR sidelink measurements of L2 UE to network (U2N) Relay UEs 102. Additionally or alternatively, the network may configure the UE 102 to report the following measurement information based on SS/PBCH block(s) (SSB(s)): measurement results per SSB; measurement results per cell based on SSB(s); and/or SSB(s) indexes. Additionally or alternatively, the network may configure the UE 102 to report the following measurement information based on CSI-RS resources: measurement results per CSI-RS resource; measurement results per cell based on CSI-RS resource(s); and/or CSI-RS resource measurement identifiers. Additionally or alternatively, the network may configure the UE 102 to perform the following types of measurements for NR sidelink and V2X sidelink channel busy ratio (CBR) measurements. Additionally or alternatively, the network may configure the UE 102 to report the following cross link interference (CLI) measurement information based on SRS resources measurement results per SRS resource; and SRS resource(s) indexes. Additionally or alternatively, the network may configure the UE 102 to report the following CLI measurement information based on CLI-RSSI resources: measurement results per CLI-RSSI resource; and CLI-RSSI resource(s) indexes. Additionally or alternatively, the network may configure the UE 102 to report the following Rx-Tx time difference measurement information based on CSI-RS for tracking or PRS: UE Rx-Tx time difference measurement result. Additional or alternative measurement types can be configured as discussed in [TS38331].

Each measurement configuration (e.g., measConfig IE discussed in [TS38331]) includes the following parameters: list of measurement objects (MOs), reporting configurations, measurement identities, quantity configurations, and measurement gap (MG) configuration (e.g., measGapConfig IE discussed in [TS38331]). In some implementations, the measConfig also includes a measurement gap sharing scheme (e.g., MeasGapSharingConfig IE, which controls setup and/or release of measurement gap sharing (see e.g., [TS38331])). When the UE 102 receives a measConfig (e.g., in a suitable RRC message), the UE 102 performs various operations/actions discussed in [TS38331] § 5.5.

For each measurement type one or several MOs can be defined. The MO(s) comprises a list of objects on which the UE 102 is to perform measurements (see e.g., measObjectToAddModList and/or measObjectToRemoveList discussed in [TS38331]). For intra-frequency and inter-frequency measurements, an MO indicates the frequency/time location and subcarrier spacing (SCS) of RSs to be measured. Associated with this MO, the network may configure a list of cell specific offsets, a list of ‘exclude-listed’ cells (e.g., cells that are not applicable in event evaluation or measurement reporting), and/or a list of ‘allow-listed’ cells (e.g., cells that are the only ones applicable in event evaluation or measurement reporting). The measObjectId of the MO which corresponds to each serving cell is indicated by servingCellMO within the serving cell configuration. For inter-RAT E-UTRA measurements, an MO is a single E-UTRA carrier frequency. Associated with this E-UTRA carrier frequency, the network can configure a list of cell specific offsets and a list of ‘exclude-listed’ cells. For inter-RAT UTRA-FDD measurements, an MO is a set of cells on a single UTRA-FDD carrier frequency. In some examples, if the received measConfig includes the measObjectToRemoveList, the UE 102 performs the measurement object removal procedure specified in [TS38331] § 5.5.2.4; and If the received measConfig includes the measObjectToAddModList, the UE 102 performs the measurement object addition/modification procedure specified in [TS38331] § 5.5.2.5.

For each MO, one or several reporting configurations can be defined. For example, a list of reporting configurations can be provided where there can be one or multiple reporting configurations per MO (e.g., reportConfigToAddModList IE and/or reportConfigToRemoveList IIE discussed in [TS38331]). Each measurement reporting configuration includes a reporting criterion, an RS type, and a reporting format. The reporting criterion is a criterion that triggers the UE 102 to send a measurement report. The trigger/condition can be event triggered reporting, periodic reporting, and event triggered periodic reporting. The RS type is the RS that the UE 102 uses for beam and/or cell measurement results (e.g., SSB or CSI-RS). The reporting format includes the quantities per cell and per beam that the UE 102 includes in the measurement report (e.g., RSRP and/or some other measurement types) and other associated information, such as the maximum number of cells and the maximum number beams per cell to report. In case of conditional reconfiguration, each configuration includes: execution criteria and RS types. The execution criteria is the criteria the UE 102 uses for conditional reconfiguration execution, and the RS type is the RS that the UE 102 uses for obtaining beam and cell measurement results (e.g., SSB-based or CSI-RS-based) used for evaluating conditional reconfiguration execution condition. In some examples, if the received measConfig includes the reportConfigToRemoveList, the UE 102 performs the reporting configuration removal procedure specified in [TS38331] § 5.5.2.6; and if the received measConfig includes the reportConfigToAddModList, the UE 102 performs the reporting configuration addition/modification procedure specified in [TS38331] § 5.5.2.7.

The association between an MO and a reporting configuration is created by a measurement identity (measId) (e.g., measIdToAddModList IE and/or measIdToRemoveList IE discussed in [TS38331]). For measurement reporting, a list of measIds where each measId links one MO with one reporting configuration. By configuring multiple measIds, it is possible to link more than one MO to the same reporting configuration, as well as to link more than one reporting configuration to the same MO. The measurement identity is also included in the measurement report that triggered the reporting, serving as a reference to the network. For conditional reconfiguration triggering, one measurement identity links to exactly one conditional reconfiguration trigger configuration, and up to two measIds can be linked to one conditional reconfiguration execution condition. In some examples, if the received measConfig includes the measIdToRemoveList, the UE 102 performs the measurement identity removal procedure specified in [TS38331] § 5.5.2.2; and if the received measConfig includes the measIdToAddModList, the UE 102 performs the measurement identity addition/modification procedure specified in [TS38331] § 5.5.2.3.

A quantity configuration (e.g., quantityConfig IE discussed in [TS38331])) defines the measurement filtering configuration used for all event evaluation and related reporting, and for periodical reporting of that measurement. For NR measurements, the network may configure up to two quantity configurations with a reference in the NR MO to the configuration that is to be used. In each configuration, different filter coefficients can be configured for different measurement quantities, for different RS types, and for measurements per cell and per beam. In some examples, measurement quantities are considered separately for each RAT (or RAN 104), and measurement commands may be used by the NG-RAN 104 to order the UE 102 to start, modify, or stop measurements. In some examples, if the received measConfig includes the quantityConfig, the UE 102 performs the quantity configuration procedure specified in [TS38331] § 5.5.2.8.

The MGs are periods during which the UE 102 may use to perform measurements. In some examples, if the received measConfig includes the measGapConfig, the UE 102 performs the measurement gap configuration procedure specified in [TS38331] § 5.5.2.9. The network provides a single per-UE MG pattern for concurrent monitoring of all frequency layers if the UE 102 requires MGs to identify and measure intra-frequency cells, inter-frequency cells, and/or inter-RAT cells, and the UE 102 does not support independent MG patterns for different FRs. If the UE 102 requires MGs to identify and measure intra-frequency cells, inter-frequency cells, and/or inter-RAT E-UTRAN cells, and the UE 102 supports independent MG patterns for different FRs, the network provides either per-FR MG patterns for an FR where UE 102 requires per-FR MG for concurrent monitoring of all frequency layers of each frequency range independently, or a single per-UE MG pattern for concurrent monitoring of all frequency layers of all frequency ranges. For example, the parameter gapType indicates an MG type of this MG, where the value perUE indicates that it is a per-UE MG, value perFR1 indicates that it is an FR1 MG, and value perFR2 indicates that it is an FR2 MG. Additionally, the parameter gapUE indicates an MG configuration that applies to all frequencies (FR1 and FR2). In some implementations for NR-DC, the parameter gapUE is only set up in the measConfig associated with an MCG, and neither gapFR1 nor gapFR2 parameters are configured if gapUE is configured. The applicability of the per-UE MG is according to tables 9.1.2-2 and 9.1.2-3 in [TS38133].

During the per-UE MGs the UE 102 is not required to conduct reception/transmission from/to the corresponding NR serving cells for SA (with single carrier or CA configured) except the reception of signals used for RRM measurement(s), PRS measurement(s) and the signals used for random access procedure according to [TS38321]; and is not required to conduct reception/transmission from/to the corresponding NR serving cells for NR-DC except the reception of signals used for RRM measurement(s), PRS measurement(s) and the signals used for random access procedure according to [TS38321]. During the per-FR MGs the UE 102 is not required to conduct reception/transmission from/to the corresponding NR serving cells in the corresponding frequency range for SA (with single carrier or CA configured) except the reception of signals used for RRM measurement(s), PRS measurement(s) and the signals used for random access procedure according to [TS38321]; and is not required to conduct reception/transmission from/to the corresponding NR serving cells in the corresponding frequency range for NR-DC except the reception of signals used for RRM measurement(s), PRS measurement(s) and the signals used for random access procedure according to [TS38321]. The UE 102 supports the MG patterns listed in Table 9.1.2-1 of [TS38133] based on the applicability specified in table 9.1.2-2 and 9.1.2-3 of [TS38133]. The UE 102 determines MG timing based on gap offset configuration and MG timing advance (MGTA) configuration provided by higher layer signaling as specified in [TS38331] and [TS36331]. In NR-DC mode, if per-UE MG is configured with MGTA of T_{MG} MS, the MG starts at time T_{MG} ms advanced to the end of the latest MCG subframe occurring immediately before the configured MG among MCG serving cells subframes. If per-FR MG for FR1 is configured with MGTA of T_{MG} ms, the MG for FR1 starts at time T_{MG} ms advanced to the end of the latest MCG subframe occurring immediately before the configured MG among MCG serving cells subframes. T_{MG} is the MGTA value provided in mgta (in milliseconds (ms)) according to [TS38331]. In determining the MG starting point, the UE 102 uses the DL timing of the latest subframe occurring immediately before the configured MG among serving cells.

The MG configuration may also include an mgrp field, which indicates a measurement gap repetition period (MGRP) in ms of the MG according to Table 9.1.2-1 in [TS38133]. If ncsgInd-r17 is present, the mgrp field indicates the Visible Interruption Repetition Period (VIRP) of NCSG pattern and is configured according to Table 9.1.9.3-1 in [TS38133]. The MG configuration may also include an MG length (MGL) field (mgl). A value mgl (in the mgl field) is the MGL in ms of the MG. If ncsgInd-r17 is not present, the MGL is according to in Table 9.1.2-1 in [TS38133]. If ncsgInd-r17 is present, the mgl field indicates the measurement length (ML) in NCSG pattern and is configured according to Table 9.1.9.3-1 in [TS38133]. Value msldot5 corresponds to 1.5 ms, ms3 corresponds to 3 ms and so on. If mgl-r16 is present, the UE 102 ignores the mgl (without suffix). Value ms1, ms2, and ms5 can only be configured if ncsgInd is present.

For a UE 102 with NR-DC operation and configured with per-UE MG, MG sharing applies when the UE 102 requires MGs to identify and measure cells on intra-frequency carriers or when SMTC configured for intra-frequency measurement are fully overlapping with per-UE measurement gaps, and when the UE 102 requires measurement gaps to identify and measure cells on inter-frequency carriers for both SSB and CSI-RS-based L3 measurement, and/or inter-RAT E-UTRAN carriers, or when all of SMTC configured for inter-frequency SSB-based measurement without measurement gaps are fully overlapping with per-UE measurement gaps, and/or inter-RAT UTRAN carriers for SRVCC, and when the UE 102 is configured to measure positioning frequency layers. For a UE 102 with NR-DC operation and configured with per-FR1 measurement gap, measurement gap sharing is applied when the UE 102 requires measurement gaps to identify and measure cells on FR1 intra-frequency carriers or when SMTC configured for FR1 intra-frequency measurement are fully overlapping with per-FR1 measurement gaps, and when the UE 102 requires measurement gaps to identify and measure cells on FR1 inter-frequency carriers for both SSB and CSI-RS-based L3 measurement and/or inter-RAT E-UTRAN carriers, or when all of SMTC configured for inter-frequency SSB-based measurement without measurement gaps are fully overlapping with per-FR1 measurement gaps, and/or inter-RAT UTRAN carriers for Single Radio Voice Call Continuity (SRVCC), and when the UE 102 is configured to measure positioning frequency layers in FR1. The network (e.g., RAN 104 and/or RAN node 114) signals the RRC parameter measGapSharingConfig (see e.g., [TS38331]) with a value of “01” to indicate 25% splitting, a value of “10” to indicate 50% splitting, a value of “11” to indicate 75% splitting, or a value of “00”” to indicate equal splitting gap sharing and/or gap sharing is not applied. The splitting value is applied as shown by equations 2.1-1 and 2.1-2.

$${K}_{intra} = 1 / X * 100 \qquad ( 2.1 - 1 )$$

$${K}_{inter} = 1 / ( 100 - X ) * 100 \qquad ( 2.1 - 2 )$$

In equations 2.1-1 and 2.1-2, X is the splitting value provided in the measGapSharingConfig parameter, and K is a scaling factor, offset, or other parameter. It is left to UE implementation to determine which measurement gap sharing scheme is to be applied, when MeasGapSharingScheme is absent and there is no stored value in the field. The RRC parameter MeasGapSharingScheme is applied to the calculation of carrier specific scaling factor as specified in clause 9.1.5.2.4 of [TS38133] and/or as discussed herein (see e.g., section 1.4.2.1, supra). In some examples, if the received measConfig includes the measGapSharingConfig, the UE 102 performs the measurement gap sharing configuration procedure specified in [TS38331] § 5.5.2.11.

A UE 102 in RRC_CONNECTED maintains an MO list, a reporting configuration list, and a measIds list according to signaling and procedures discussed in [TS38331]. The MO list includes NR MO(s), CLI MO(s), inter-RAT objects, and/or L2 U2N Relay objects. Additionally or alternatively, the reporting configuration list includes NR, inter-RAT, and/or L2 U2N Relay reporting configurations. Any MO can be linked to any reporting configuration of the same RAT type. Some reporting configurations may not be linked to a MO. Likewise, some MOs may not be linked to a reporting configuration. The measurement procedures distinguish the following types of cells: (1) the NR serving cell(s) (e.g., the SpCell and one or more SCells; (2) listed cells (e.g., the cells listed within the MO(s) or MO list); and (3) detected cells (e.g., the cells that are not listed within the MO(s), but are detected by the UE 102 on the SSB frequency(ies) and SCS(s) indicated by the MO(s)).

For NR MO(s), the UE 102 measures and reports on the serving cell(s)/serving Relay UE 102 (for L2 U2N Remote UE 102), listed cells and/or detected cells. For inter-RAT measurements object(s) of E-UTRA, the UE 102 measures and reports on listed cells and detected cells and, for RSSI and channel occupancy measurements, the UE 102 UE measures and reports on the configured resources on the indicated frequency. For inter-RAT measurements object(s) of UTRA-FDD, the UE 102 measures and reports on listed cells. For CLI MO(s), the UE measures and reports on configured measurement resources (e.g. SRS resources and/or CLI-RSSI resources). For L2 U2N Relay object(s), the UE measures and reports on the serving NR cell(s), as well as the discovered L2 U2N Relay UEs. Whenever a procedural specification, other than contained in clause 5.5.2 of [TS38331], refers to a field it concerns a field included in the VarMeasConfig unless explicitly stated otherwise (e.g., only the measurement configuration procedure covers the direct UE action related to the received measConfig).

In MR-DC (or NR-DC), the UE 102 may receive at least two independent measConfigs, including: a measConfig associated with an MCG that is included in the RRCReconfiguration message received via SRB1; and a measConfig associated with SCG that is included in an RRCReconfiguration message received via system resource block 3 (SRB3) or included within a RRCReconfiguration message embedded in a RRCReconfiguration message received via system resource block 1 (SRB1). In some implementations, multiple measConfigs can be obtained, each of which is associated with an SCG. In this case, the UE 102 maintains two independent VarMeasConfig and VarMeasReportList, one associated with each measConfig, and independently performs all the procedures in clause 5.5 of [TS38331] for each measConfig and the associated VarMeasConfig and VarMeasReportList, unless explicitly stated otherwise. The configurations related to CBR measurements are only included in the measConfig associated with MCG. The configurations related to Rx-Tx time difference measurement are only included in the measConfig associated with MCG.

For performing measurements, an RRC_CONNECTED UE 102 derives cell measurement results by measuring one or multiple beams associated per cell as configured by the network (e.g., RAN 104 and/or an individual RAN node 114), as described in 5.5.3.3 of [TS38331] and/or as described infra w.r.t FIG. 4. For all cell measurement results, except for RSSI and CLI measurement results in RRC_CONNECTED, the UE 102 applies the L3 filtering as specified in 5.5.3.2 of [TS38331] and/or as described infra w.r.t FIG. 4, before using the measured results for evaluation of reporting criteria, measurement reporting, and/or the criteria to trigger conditional reconfiguration execution. For cell measurements, the network can configure RSRP, RSRQ, SINR, RSCP, and/or Ec/N0 as trigger quantity. For CLI measurements, the network can configure SRS-RSRP or CLI-RSSI as trigger quantity. Additional or alternative measurement types can be configured for these purposes. For cell and beam measurements, reporting quantities can be any combination of quantities (e.g., only RSRP; only RSRQ; only SINR; RSRP and RSRQ; RSRP and SINR; RSRQ and SINR; RSRP, RSRQ and SINR; only RSCP; only EcN0; RSCP and EcN0; and/or the like; additional or alternative measurement types and/or combinations can be configured for these purposes), irrespective of the trigger quantity, and for CLI measurements, reporting quantities can be either SRS-RSRP or CLI-RSSI. For conditional reconfiguration execution, the network can configure up to two quantities, both using same RS type. The UE 102 does not apply the L3 filtering as specified in 5.5.3.2 of [TS38331] to derive the CBR measurements or to derive the Rx-Tx time difference measurements. The network may also configure the UE 102 to report measurement information per-beam (which can either be measurement results per beam with respective beam identifier(s) or only beam identifier(s)), derived as described in 5.5.3.3a of [TS38331]. If beam measurement information is configured to be included in measurement reports, the UE 102 applies the L3 beam filtering as specified in 5.5.3.2 of [TS38331]. On the other hand, the exact L1 filtering of beam measurements used to derive cell measurement results may be implementation-specific.

FIG. 4 shows an example measurement model 400, which may be used by a UE 102 to measure signals, cells, channels, beams, and/or the like. In RRC_CONNECTED, the UE 102 measures at least one or multiple beams (e.g., gNB beams 1-K in FIG. 4) of a cell and the measurements results (e.g., power values, signal strength, signal quality, interference, and/or the like) are averaged to derive the cell quality. In doing so, the UE 102 is configured to consider a subset of the detected beams. Filtering takes place at two different levels: at the physical layer to derive beam quality and then at RRC level to derive cell quality from multiple beams. Cell quality from beam measurements is derived in the same way for the serving cell(s) and for the non-serving cell(s). Measurement reports may contain the measurement results of the X best beams if the UE 102 is configured to do so by the gNB 114a.

Point A includes measurements (e.g., beam-specific samples) internal to the PHY layer, which are provided to layer 1 (L1) filtering. The beam-specific samples include 1-K gNB beams (where K is a number). In some examples, K beams correspond to the measurements on synchronization signal block (SSB) and/or CSI-RS resources configured for L3 mobility by a gNB 114a and detected by the UE 102 at LL. L1 filtering includes internal L1 filtering of the inputs measured at point A. The specific filtering mechanisms and/or techniques actually executed in the PHY layer is/are implementation-specific.

Point A¹ includes measurements (e.g., beam-specific measurements) reported by L1 to L3 after L1 filtering. At the beam consolidation/selection element, beam specific measurements are consolidated to derive cell quality. The behavior of the beam consolidation/selection element is configurable, and the configuration of this module is provided by RRC signalling. In some examples, the reporting period at point B equals one measurement period at point A¹.

Point B Point (e.g., cell quality) derived from beam-specific measurements reported to L3 after beam consolidation/selection. The L3 filtering for cell quality element performs filtering on the measurements provided at point B. The behavior of the L3 filters is configurable, and the configuration of this module is provided by RRC signalling. In some examples, the filtering reporting period at point C equals one measurement period at point B.

Point C includes the measurement(s) after processing in the L3 filter. In some examples, the reporting rate is identical to the reporting rate at point B. This measurement is used as input for one or more evaluation of reporting criteria.

The evaluation of reporting criteria element checks whether actual measurement reporting is necessary at point D. The evaluation can be based on more than one flow of measurements at reference point C (e.g., to compare between different measurements). This is illustrated by input C and input C¹. The UE 102 evaluates the reporting criteria at least every time a new measurement result is reported at point C, C¹. The reporting criteria is/are configurable, and the configuration is provided by RRC signalling (e.g., UE measurements). At point D, measurement report information (message) is sent on the radio interface.

The L3 beam filtering element performs filtering on the measurements (e.g., beam specific measurements) provided at point A¹. The behavior of the beam filters is configurable, and the configuration of the beam filters is provided by RRC signalling. In some examples, the filtering reporting period at point E equals one measurement period at point A¹.

Point E includes the measurement(s) (e.g., beam-specific measurement) after processing in the L3 beam filter. In some examples, the reporting rate is identical to the reporting rate at point A¹. This measurement is used as input for selecting the X measurements to be reported.

The beam selection for beam reporting element selects the X measurements from the measurements provided at point E. The behavior of the beam selection is configurable and the configuration of this module is provided by RRC signalling. Point F includes beam measurement information included in measurement report (sent) on the radio interface.

L1 filtering introduces a certain level of measurement averaging. How and when the UE 102 exactly performs the required measurements is implementation specific to the point that the output at point B fulfils the performance requirements set in [TS38133]. L3 filtering for cell quality and related parameters used are specified in [TS38331] and do not introduce any delay in the sample availability between points B and C. Measurement at points C, C¹ is the input used in the event evaluation. L3 beam filtering and related parameters used are specified in [TS38331] and do not introduce any delay in the sample availability between points E and F.

Measurement reports are characterized by the following: measurement reports include the measId of the associated measurement configuration that triggered the reporting; cell and beam measurement quantities to be included in measurement reports are configured by the network; the number of non-serving cells to be reported can be limited through configuration by the network; cells belonging to an exclude-list configured by the network are not used in event evaluation and reporting, and conversely when an allow-list is configured by the network, only the cells belonging to the allow-list are used in event evaluation and reporting; and beam measurements to be included in measurement reports are configured by the network (e.g., beam identifier only, measurement result and beam identifier, or no beam reporting).

Intra-frequency neighbor (cell) measurements and inter-frequency neighbor (cell) measurements are defined as follows: SSB-based intra-frequency measurement; SSB-based inter-frequency measurement; CSI-RS-based intra-frequency measurement; and CSI-RS-based inter-frequency measurement.

An SSB-based intra-frequency measurement is a measurement is defined as an SSB-based intra-frequency measurement provided the center frequency of the SSB of the serving cell and the center frequency of the SSB of the neighbor cell are the same, and the subcarrier spacing of the two SSBs is also the same. An SSB-based inter-frequency measurement is a measurement is defined as an SSB-based inter-frequency measurement provided the center frequency of the SSB of the serving cell and the center frequency of the SSB of the neighbor cell are different, or the subcarrier spacing of the two SSBs is different. In some examples, for SSB-based measurements, one MO corresponds to one SSB and the UE 102 considers different SSBs as different cells. Additionally or alternatively, if a reduced capability (RedCap) UE 102 is configured to perform serving cell measurements based on an Non Cell Defining (NCD)-SSB configured in its active BWP, this NCD-SSB is considered as the SSB of the serving cell in the definition of intra-frequency and inter-frequency measurements as above. A RedCap UE 102 is a UE 102 with reduced capabilities as specified in clause 4.2.21.1 in 3GPP TS 38.306.

A CSI-RS-based intra-frequency measurement is a measurement is defined as a CSI-RS-based intra-frequency measurement provided that: the subcarrier spacing of CSI-RS resources on the neighbor cell configured for measurement is the same as the SCS of CSI-RS resources on the serving cell indicated for measurement; for 60 kHz subcarrier spacing, the CP type of CSI-RS resources on the neighbor cell configured for measurement is the same as the CP type of CSI-RS resources on the serving cell indicated for measurement; and the center frequency of CSI-RS resources on the neighbor cell configured for measurement is the same as the center frequency of CSI-RS resource on the serving cell indicated for measurement. A CSI-RS-based inter-frequency measurement is a measurement is defined as a CSI-RS-based inter-frequency measurement if it is not a CSI-RS-based intra-frequency measurement. In some implementations, extended CP for CSI-RS-based measurement is not supported.

The UE 102 is able to identify new intra-frequency cells and perform various measurements (e.g., SS-RSRP, SS-RSRQ, SS-SINR, and/or other measurement types) of identified intra-frequency cells if carrier frequency information is provided by the PCell or the PSCell, even if no explicit neighbor list with physical layer cell identities is provided. The UE 102 is able to perform intra-frequency measurements as described in [TS38133] § 9.2 (e.g., including without MGs as described in [TS38133] § 9.2.5 and/or with MGs as described in [TS38133]§ 9.2.6). The UE 102 is able to identify new inter-frequency cells and perform various measurements (e.g., SS-RSRP, SS-RSRQ, SS-SINR, and/or other measurement types) of identified inter-frequency cells if carrier frequency information is provided by PCell or PSCell, even if no explicit neighbor list with physical layer cell identities is provided. The UE 102 is able to perform intra-frequency measurements as described in [TS38133] § 9.3 (e.g., including without MGs as described in [TS38133] § 9.3.9 and/or with MGs as described in [TS38133] § 9.3.4).

Whether a measurement is non-gap-assisted or gap-assisted depends on the capability of the UE 102, the active BWP of the UE 102, and the current operating frequency. For SSB-based inter-frequency measurement, if the MG requirement information is reported by the UE 102, a MG configuration may be provided according to the information. Otherwise, a MG configuration is always provided in the following cases: if the UE 102 only supports per-UE MGs; and/or if the UE 102 supports per-FR MGs and any of the serving cells are in the same frequency range of the MO. For SSB-based intra-frequency measurement, if the MG requirement information is reported by the UE 102, a MG configuration may be provided according to the information. Otherwise, a MG configuration is always provided in the following case: other than the initial BWP, if any of the UE 102 or RedCap UE 102 configured BWPs do not contain the frequency domain resources of the SSB associated to the initial DL BWP, and for RedCap UE 102, are not configured with NCD-SSB for serving cell measurement. In non-gap-assisted scenarios, the UE 102 is able to carry out such measurements without MGs. In gap-assisted scenarios, the UE 102 cannot be assumed to be able to carry out such measurements without MGs.

The network (e.g., RAN 104 and/or RAN node 114) may request the UE 102 to measure NR and/or E-UTRA carriers in RRC_IDLE or RRC_INACTIVE via system information or via dedicated measurement configuration in an RRCRelease message. If the UE 102 was configured to perform measurements of NR and/or E-UTRA carriers while in RRC_IDLE or in RRC_INACTIVE, it may provide an indication of the availability of corresponding measurement results to the gNB 114a in the RRCSetupComplete message. The network may request the UE 102 to report those measurements after security activation. The request for the measurements can be sent by the network immediately after transmitting the security mode command (e.g., before the reception of the security mode complete from the UE 102).

If the UE 102 was configured to perform measurements of NR and/or E-UTRA carriers while in RRC_INACTIVE, the gNB 114a can request the UE 102 to provide corresponding measurement results in the RRCResume message and then the UE 102 can include the available measurement results in the RRCResumeComplete message. Additionally or alternatively, the UE 102 may provide an indication of the availability of the measurement results to the gNB 114a in the RRCResumeComplete message and the gNB 114a can then request the UE 102 to provide these measurement results.

### 3. Example Implementations

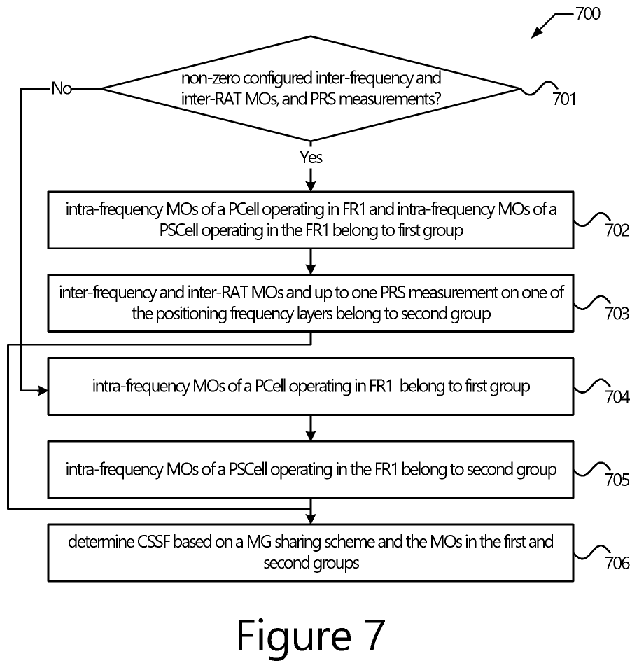

FIG. 5 shows an example process 500 that can be performed by a UE 102 capable of operating in NR-DC, including FR1+FR1 NR-DC. Process 500 begins at operation 501 where the UE 102 determines a measurement occasion during which to perform one or more signal measurements. The UE 102 determines the measurement occasion based on at least one measurement configuration of at least two measurement configurations that were obtained from the network (e.g., RAN 104 and/or RAN node 114) and stored by the UE 102; the at least two measurement configurations include a first measurement configuration for an MCG cell operating in FR1 and a second measurement configuration for an SCG cell operating in FR1. The measurement occasion can include, for example, a configured MG, an SMTC period, or a CSI-RS resource period, either of which may include a time period for PSS/SSS detection, a time period for time index detection, and/or a measurement period for performing intra-frequency and/or inter-frequency measurements. At operation 502, the UE 102 determines or derives a carrier-specific scaling factor (CSSF). At operation 503, the UE 102 scales or otherwise adjusts the determined measurement occasion based on the CSSF. At operation 504, the UE 102 performs the one or more signal measurements during the scaled measurement occasion.

FIG. 6 shows an example process 600 that can be performed by a UE 102 that is not configured with MGs. In some examples, process 600 may be performed at operation 502 of process 500. Process 600 begins at operation 601 where the UE 102 determines a CSSF for an FR1 PCC. In an example, the CSSF for the FR1 PCC is 1+N_{PCC_CSIRS} where N_{PCC_CSIRS} is a number of configured PCells, and N_{PCC_CSIRS} is 1 if the FR1 PCC is configured with either both SSB and CSI-RS based L3 measurement or only CSI-RS based L3 measurement; otherwise, N_{PCC_CSIRS} is 0. At operation 602, the UE 102 determines a CSSF for an FR1 SCC. In an example, the CSSF for the FR1 SCC is 2×(N_{SCC_SSB}+Y+2×N_{SCC_CSIRS}) where the N_{SCC_SSB} is a number of configured SCells with only SSB based L3 measurement configured which is measured without MG, the N_{SCC_CSIRS} is a number of configured SCells with either both SSB and CSI-RS based L3 measurement configured or only CSI-RS based L3 measurement configured, and Y is the number of configured inter-frequency SSB based frequency layers without MG that are being measured outside of MG; otherwise, Y is 0. At operation 603, the UE 102 determines a CSSF for an FR1 PSCC, if any. In an example, the CSSF for the FR1 PSCC is 2×(1+N_{PSCC_CSIRS}) where N_{PSCC_CSIRS} is 1 if the PSCC is configured with both SSB and CSI-RS based L3 measurement or only configured with CSI-RS based L3 measurement; otherwise, NₚSCC_CSIRS is 0. In this example, the CSSF is 1 if no SCell is configured and no inter-frequency MO without gap and only SSB based L3 measurement is configured on the PSCC; the CSSF is 2 if no SCell is configured and no inter-frequency MO without gap and either both SSB and CSI-RS based L3 measurement is configured or only CSI-RS based L3 measurement is configured on the PSCC. At operation 604, the UE 102 determines a CSSF for an inter-frequency MO with no MG, if any. In an example, the CSSF for the inter-frequency MO with no MG is 2×(N_{SCC_SSB}+Y+2×N_{SCC_CSIRS}) where the N_{SCC_SSB} is a number of configured SCells with only SSB based L3 measurement configured which is measured without MG, the N_{SCC_CSIRS} is a number of configured SCells with either both SSB and CSI-RS based L3 measurement configured or only CSI-RS based L3 measurement configured, and Y is the number of configured inter-frequency SSB based frequency layers without MG that are being measured outside of MG; otherwise, Y is 0.

FIG. 7 shows an example process 700 that can be performed by a UE 102 configured with MGs. In some examples, process 700 may be performed at operation 502 of process 500. Process 700 begins at operation 701 where the UE 102 determines whether a number of configured inter-frequency and inter-RAT MOs and NR PRS measurements on all positioning frequency layers is non-zero, and whether the UE 102 is configured with per-UE gaps or per-FR gaps. If yes, the UE 102 proceeds to operation 702 to determine of classify intra-frequency MOs of an FR1 PCell and intra-frequency MOs of an FR1 PSCell as belonging to a first group (group A), and at operation 703 the UE 102 determines or classifies inter-frequency MOs and inter-RAT MOs, and up to one NR PRS measurement on any one positioning frequency layer, as belonging to a second group (group B). If at operation 701 the UE 102 determines that the number of configured inter-frequency and inter-RAT MOs and NR PRS measurements on all positioning frequency layers is zero, then the UE 102 proceeds to operation 703 to determine of classify the intra-frequency MOs of FR1 PCell belong to the first group (group A), and then to operation 704 to determine of classify the intra-frequency MOs of FR1 PSCell belong to the second group (group B). At operation 705, the UE 102 determines the appropriate CSSF based on an MG sharing scheme and the number of MOs in the first and second groups. At operation 703, the UE 102 determines a configuration of the intra-frequency MOs of the primary cell to the first group in response to the number of the inter-frequency and inter-RAT MOs and PRS measurements on all positioning frequency layers zero and the UE being configured with per-UE gaps. At operation 704, the UE 102 determines a configuration of the intra-frequency MOs of primary secondary cell to the second group in response to the number of the inter-frequency and inter-RAT MOs and PRS measurements on all positioning frequency layers zero and the UE being configured with per-UE gaps.

The examples operations of processes 500-700 can be arranged in different orders, one or more of the depicted operations may be combined and/or divided/split into multiple operations, depicted operations may be omitted, and/or additional or alternative operations may be included in any of the depicted processes.

Additional examples of the presently described methods, devices, systems, and networks discussed herein include the following, non-limiting implementations. Each of the following non-limiting examples may stand on its own or may be combined in any permutation or combination with any one or more of the other examples provided below or throughout the present disclosure.

Example 1 includes a method, comprising: requirements for frequency range 1 (FR1)+FR1 new radio (NR)-dual connectivity (DC) are applicable for a user equipment (UE) configured with a number of serving NR component carriers (CCs).

Example 2 includes the method of example 1 and/or some other example(s) herein, wherein the number of serving NR CCs includes: up to 10 NR DL CCs in total, with 1 UL in primary cell (PCell), 1 UL in primary secondary cell group cell (PSCell), and up to 1 UL in each secondary cell (SCell).

Example 3 includes the method of example 1 and/or some other example(s) herein, wherein the number of serving NR CCs includes: up to 5 NR DL CCs in PCell and up to 5 DL CCs in PSCell, with 1 UL in PCell, 1 UL in PSCell, and up to 1 UL in each SCell.

Example 4 includes the method of example 1 and/or some other example(s) herein, wherein the number of serving NR CCs includes: up to 10 NR DL CCs in total, with 1 UL in PCell, 1 UL in PSCell, and up to 8 UL SCell.

Example 5 includes the method of examples 1-4 and/or some other example(s) herein, wherein for PSCell addition in FR1+FR1 NR-DC, a delay is: T_{config_PSCell}=T_{RRC_delay}+T_{processing}+T_{search}+T_{Δ}+T_{PSCell_DU}+2 ms, wherein T_{RRC_delay} is a radio resource control (RRC) procedure delay; T_{processing} is a software (SW) processing time needed by UE, including an RF warm up period; T_{search} is a time for automatic gain control (AGC) settling and primary synchronization signal (PSS)/secondary synchronization signal (SSS) detection; TA is time for fine time tracking and acquiring full timing information of a target cell; T_{PSCell_DU} is a delay uncertainty in acquiring a first available physical random access channel (PRACH) occasion in a primary secondary cell (PSCell); and T_{PSCell_DU} is up to a summation of synchronization signal block (SSB) to PRACH occasion association period and 10 milliseconds (ms).

Example 6 includes the method of example 5 and/or some other example(s) herein, wherein T_{search}=0 ms if the target cell is known.

Example 7 includes the method of example 5 and/or some other example(s) herein, wherein T_{search}=(24*Tᵣₛ)ms if the target cell is unknown and the target cell Ês/Iot≥−2 dB.

Example 8 includes the method of example 5 and/or some other example(s) herein, wherein T_{search}=(3*Tᵣₛ)ms for FR1-FR1 NR-DC.

Example 9 includes the method of examples 6-8 and/or some other example(s) herein, wherein Tᵣₛ is an SSB-based Measurement Timing configuration (SMTC) periodicity of a target cell if the UE has been provided with an SMTC configuration for the target cell in PSCell addition message, otherwise Tᵣₛ is an SMTC configured in an measObjectNR having a same SSB frequency and subcarrier spacing.

Example 10 includes the method of example 9 and/or some other example(s) herein, wherein Tᵣₛ=5 ms if the UE is not provided SMTC configuration or measurement object on this frequency and an SSB transmission periodicity is 5 ms.

Example 11 includes the method of examples 5-10 and/or some other example(s) herein, wherein T_{processing}=40 ms or T_{processing}=20 ms.

Example 12 includes the method of examples 5-11 and/or some other example(s) herein, wherein T_{Δ}=(1*Tᵣₛ)ms for a known or unknown PSCell.

Example 13 includes the method of examples 1-12 and/or some other example(s) herein, wherein there are no scheduling restrictions on FR1 serving cells due to radio link monitoring (RLM) performed on FR1 PSCell.

Example 14 includes the method of examples 1-13 and/or some other example(s) herein, wherein the method includes: determining a carrier-specific scaling factor (CSSF) for measurements to be conducted outside measurement gaps (CSSF_{outside_gap,i}) for FR1+FR1 NR-DC.

Example 15 includes the method of example 14 and/or some other example(s) herein, wherein the CSSF_{outside_gap,i} is 1+N_{PCC_CSIRS} for an FR1 primary component carrier (PCC).

Example 16 includes the method of example 15 and/or some other example(s) herein, wherein the N_{PCC_CSMS}=1 if the PCC is configured with only CSI-RS-based L3 measurement or configured with both SSB and CSI-RS-based L3 measurement; otherwise, N_{PCC_CSRS}=0.

Example 17 includes the method of example 14 and/or some other example(s) herein, wherein the CSSF_{outside_gap,i} is 2×(1+N_{PSCC_CSIRS}) for an FR1 primary secondary component carrier (PSCC).

Example 18 includes the method of example 17 and/or some other example(s) herein, wherein the N_{PSCC_CSIRS}=1 if the PSCC is configured with both SSB and CSI-RS-based L3 measurement or configured with only CSI-RS-based L3 measurement; otherwise, N_{PSCC_CSIRS}=0.

Example 19 includes the method of examples 17-18 and/or some other example(s) herein, wherein the CSSF_{outside_gap,i}=1 if no SCell is configured, no inter-frequency measurement object without gap is configured, and/or only SSB-based L3 measurement is configured on the PSCC.

Example 20 includes the method of examples 17-18 and/or some other example(s) herein, wherein the CSSF_{outside_gap,i}=2 if no SCell is configured, no inter-frequency measurement object without gap is configured, and/or either both SSB and CSI-RS-based L3 measurements is/are configured on the PSCC or only CSI-RS-based L3 measurement is configured on the PSCC.

Example 21 includes the method of example 14 and/or some other example(s) herein, wherein the CSSF_{outside_gap,i} is 2×(N_{SCC_SSB}+Y+2×N_{SCC_CSIRS}) for an FR1 secondary component carrier (SCC).

Example 22 includes the method of example 14 and/or some other example(s) herein, wherein the CSSF_{outside_gap,i} is 2×(N_{SCC_SSB}+Y+2×N_{SCC_CSIRS}) for an FR1 PSCell SCC.

Example 23 includes the method of example 14 and/or some other example(s) herein, wherein the CSSF_{outside_gap,i} is 2×(N_{SCC_SSB}+Y+2×N_{SCC_CSIRS}) for an inter-frequency measurement gap with no measurement gap.

Example 24 includes the method of examples 21-23 and/or some other example(s) herein, wherein Y is a number of configured inter-frequency SSB-based frequency layers without measurement gap that are being measured outside of the measurement gap; otherwise, Y=0.

Example 25 includes the method of examples 21-24 and/or some other example(s) herein, wherein the N_{SCC_CSIRS} is a number of configured SCell(s) configured with either both SSB and CSI-RS-based L3 measurement or configured with only CSI-RS-based L3 measurement.

Example 25 includes the method of examples 21-24 and/or some other example(s) herein, wherein the N_{SCC_SSB} is a number of configured SCell(s) configured with only SSB-based L3 measurement, which is measured without measurement gap.

Example 26 includes the method of examples 1-25 and/or some other example(s) herein, wherein the method includes: determining a CSSF for a target measurement object to be monitored within measurement gaps (CSSF_{within_gap,i}) for FR1+FR1 NR-DC.

Example 27 includes the method of example 26 and/or some other example(s) herein, wherein if a measurement gap sharing scheme is an equal sharing scheme, then the CSSF_{within_gap,i}=max(ceil(R₁×M_{tot,i,j})), where j=0 . . . (160/MGRP)−1, wherein max is a maximum function, ceil is a ceiling function, Rᵢ is a maximal ratio of a number of measurement gaps where measurement object i is a candidate to be measured over a number of measurement gaps j, and M_{tot,i,j} is a total number of measurement objects in a group A and group B wherein group A and group B contain different sets of measurement objects.

Example 28 includes the method of example 26 and/or some other example(s) herein, wherein if a measurement gap sharing scheme is not an equal sharing scheme, and measurement object i is a group A measurement object, then the CSSF_{within_gap,i} is a maximum among (i) ceil(R₁×Kᵢₙₜᵣₐ×M_{groupA,i,j}) in gaps where M_{groupB,i,j}≠0 and j=0 . . . (160/MGRP)−1 and (ii) ceil(Rᵢ×M_{groupA,i,j}) in gaps where M_{groupB,i,j}=0, where j=0 . . . (160/MGRP)−1; and measurement object i is an group B measurement object, then the CSSF_{within_gap,i} is the maximum among (iii) ceil(Rᵢ×Kᵢₙₜₑᵣ×M_{groupBi,j}) in gaps where M_{groupA,i,j}≠0, where j=0 . . . (160/MGRP)−1 and (iv) ceil(Rᵢ×M_{groupB,i,j}) in gaps where M_{groupA,i,j}=0, where j=0 . . . (160/MGRP)−1, wherein max is a maximum function, ceil is a ceiling function, Rᵢ is a maximal ratio of a number of measurement gaps where measurement object i is a candidate to be measured over a number of measurement gaps j, and M_{groupA,i,j} is a number of FR1 intrafrequency measurement objects in a group A and M_{groupB,i,j} is a number of FR1 intrafrequency measurement objects in a group B.

Example 29 includes the method of example 28 and/or some other example(s) herein, wherein the FR1 intrafrequency measurement objects in group A are master cell group (MCG) measurement objects, and the FR1 intrafrequency measurement objects in group B are secondary cell group (SCG) measurement objects.

Example 30 includes the method of examples 27-29 and/or some other example(s) herein, wherein if a number of configured inter-frequency and inter-RAT measurement objects and Positioning Reference Signal (PRS) measurements on all positioning frequency layers is non-zero, and the UE is configured with per-UE measurement gaps, then intra-frequency measurement objects of an FR1 PCell and FR1 PSCell belong to group A; and inter-frequency and inter-RAT measurement objects and up to one NR PRS measurement on any one positioning frequency layer belong to group B.

Example 31 includes the method of examples 27-29 and/or some other example(s) herein, wherein if a number of configured inter-frequency and inter-RAT measurement objects and NR PRS measurements on all positioning frequency layers is zero and the UE is configured with per-UE measurement gaps, then intra-frequency measurement objects of an FR1 PCell belong to group A; and intra-frequency measurement objects of an FR1 PSCell belong to group B.

Example 32 includes the method of examples 27-29 and/or some other example(s) herein, wherein if a number of configured inter-frequency and inter-RAT measurement objects and NR PRS measurements on all positioning frequency layers is zero and the UE is configured with per-UE measurement gaps, then intra-frequency measurement objects of an FR1 PCell and intra-frequency measurement objects of an FR1 PSCell belong to only group A or only group B.

Example 33 includes the method of examples 1-32 and/or some other example(s) herein, wherein the method is performed by a user equipment (UE).

Example 34 includes a method of configuring user equipment (UE) by a new radio (NR) network, comprising: assigning intra-frequency measurement objects of primary cell operating in a first frequency range and a primary secondary cell operating in the first frequency range to a first group in response to a number of the inter-frequency and inter radio access technology (RAT) measurement objects and NR Positioning Reference Signal (PRS) measurements on all positioning frequency layers being greater than zero and the UE being configured with per-UE gaps; assigning the inter-frequency and inter-RAT measurement objects and up to one NR PRS measurement on one of the positioning frequency layers to a second group in response to the number of the inter-frequency and inter-RAT measurement objects and NR PRS measurements on all positioning frequency layers being greater than zero and the UE being configured with per-UE gaps; assigning the intra-frequency measurement objects of the primary cell to the first group in response to the number of the inter-frequency and inter-RAT measurement objects and NR PRS measurements on all positioning frequency layers zero and the UE being configured with per-UE gaps; and assigning the intra-frequency measurement objects of primary secondary cell to the second group in response to the number of the inter-frequency and inter-RAT measurement objects and NR PRS measurements on all positioning frequency layers zero and the UE being configured with per-UE gaps.

Example 35 includes a method of configuring user equipment (UE) that is connected to a new radio (NR) network, comprising: receiving assignments of intra-frequency measurement objects of primary cell operating in a first frequency range and a primary secondary cell operating in the first frequency range to a first group in response to a number of the inter-frequency and inter radio access technology (RAT) measurement objects and NR Positioning Reference Signal (PRS) measurements on all positioning frequency layers being greater than zero and the UE being configured with per-UE gaps; receiving assignments of the inter-frequency and inter-RAT measurement objects and up to one NR PRS measurement on one of the positioning frequency layers to a second group in response to the number of the inter-frequency and inter-RAT measurement objects and NR PRS measurements on all positioning frequency layers being greater than zero and the UE being configured with per-UE gaps; receiving assignments of the intra-frequency measurement objects of the primary cell to the first group in response to the number of the inter-frequency and inter-RAT measurement objects and NR PRS measurements on all positioning frequency layers zero and the UE being configured with per-UE gaps; and receiving assignments of the intra-frequency measurement objects of primary secondary cell to the second group in response to the number of the inter-frequency and inter-RAT measurement objects and NR PRS measurements on all positioning frequency layers zero and the UE being configured with per-UE gaps.

Example Z01 includes an apparatus comprising means for performing one or more elements of a method described in or related to any of examples 1-35, or any other method or process described herein. Example Z02 includes one or more non-transitory computer-readable media comprising instructions to cause an electronic device, upon execution of the instructions by one or more processors of the electronic device, to perform one or more elements of a method described in or related to any of examples 1-35, or any other method or process described herein. Example Z03 includes an apparatus comprising logic, modules, or circuitry to perform one or more elements of a method described in or related to any of examples 1-35, or any other method or process described herein. Example Z04 includes a method, technique, or process as described in or related to any of examples 1-35, or portions or parts thereof. Example Z05 includes an apparatus comprising: one or more processors and one or more computer-readable media comprising instructions that, when executed by the one or more processors, cause the one or more processors to perform the method, techniques, or process as described in or related to any of examples 1-35, or portions thereof. Example Z06 includes a signal as described in or related to any of examples 1-35, or portions or parts thereof. Example Z07 includes a datagram, packet, frame, segment, protocol data unit (PDU), or message as described in or related to any of examples 1-35, or portions or parts thereof, or otherwise described in the present disclosure. Example Z08 includes a signal encoded with data as described in or related to any of examples 1-35, or portions or parts thereof, or otherwise described in the present disclosure. Example Z09 includes a signal encoded with a datagram, packet, frame, segment, protocol data unit (PDU), or message as described in or related to any of examples 1-35, or portions or parts thereof, or otherwise described in the present disclosure. Example Z10 includes an electromagnetic signal carrying computer-readable instructions, wherein execution of the computer-readable instructions by one or more processors is to cause the one or more processors to perform the method, techniques, or process as described in or related to any of examples 1-35, or portions thereof. Example Z11 includes a computer program comprising instructions, wherein execution of the program by a processing element is to cause the processing element to carry out the method, techniques, or process as described in or related to any of examples 1-35, or portions thereof. Example Z12 includes a signal in a wireless network as shown and described herein. Example Z13 includes a method of communicating in a wireless network as shown and described herein. Example Z14 includes a system for providing wireless communication as shown and described herein. Example Z15 includes a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### 4. Terminology

For the purposes of the present document, the following terms and definitions are applicable to the examples and embodiments discussed herein. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The phrase “X(s)” means one or more X or a set of X. The description may use the phrases “in an embodiment,” “In some embodiments,” “in one implementation,” “In some implementations,” “in some examples”, and the like, each of which may refer to one or more of the same or different embodiments, implementations, and/or examples. Furthermore, the terms “comprising,” “including,” “having,” and the like, as used with respect to the present disclosure, are synonymous.

The term “circuitry” at least in some examples refers to a circuit or system of multiple circuits configured to perform a particular function in an electronic device. The circuit or system of circuits may be part of, or include one or more hardware components, such as a logic circuit, a processor (shared, dedicated, or group) and/or memory (shared, dedicated, or group), an application-specific integrated circuit (ASIC), field-programmable gate array (FPGA), programmable logic controller (PLC), single-board computer (SBC), system on chip (SoC), system in package (SiP), multi-chip package (MCP), digital signal processor (DSP), and the like, that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry. The term “processor circuitry” at least in some examples refers to, is part of, or includes circuitry capable of sequentially and automatically carrying out a sequence of arithmetic or logical operations, or recording, storing, and/or transferring digital data. The term “processor circuitry” at least in some examples refers to one or more application processors, one or more baseband processors, a physical CPU, a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry.” The term “memory” and/or “memory circuitry” at least in some examples refers to one or more hardware devices for storing data, including random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, read-only memory (ROM), programmable ROM (PROM), erasable PROM (EPROM), electrically EPROM (EEPROM), flash memory, non-volatile RAM (NVRAM), magnetic disk storage mediums, optical storage mediums, flash memory devices or other machine readable mediums for storing data. The term “computer-readable medium” includes, but is not limited to, memory, portable or fixed storage devices, optical storage devices, and various other mediums capable of storing, containing or carrying instructions or data. The term “interface circuitry” at least in some examples refers to, is part of, or includes circuitry that enables the exchange of information between two or more components or devices. The term “interface circuitry” at least in some examples refers to one or more hardware interfaces, for example, buses, I/O interfaces, peripheral component interfaces, network interface cards, and/or the like.

The term “device” at least in some examples refers to a physical entity embedded inside, or attached to, another physical entity in its vicinity, with capabilities to convey digital information from or to that physical entity. The term “controller” at least in some examples refers to an element or entity that has the capability to affect a physical entity, such as by changing its state or causing the physical entity to move. The term “scheduler” at least in some examples refers to an entity or element that assigns resources (e.g., processor time, network links, memory space, and/or the like) to perform tasks. The terms “network scheduler”, “packet scheduler”, “queueing discipline” or “qdisc”, and/or “queueing algorithm” at least in some examples refers to a node, element, or entity that manages network packets in transmit and/or receive queues of one or more protocol stacks of network access circuitry (e.g., a network interface controller, baseband processor, and the like).

The term “compute node” or “compute device” at least in some examples refers to an identifiable entity implementing an aspect of computing operations, whether part of a larger system, distributed collection of systems, or a standalone apparatus. In some examples, a compute node may be referred to as a “computing device”, “computing system”, or the like, whether in operation as a client, server, or intermediate entity. Specific implementations of a compute node may be incorporated into a server, base station, gateway, road side unit, on-premise unit, user equipment, end consuming device, appliance, or the like. For purposes of the present disclosure, the term “node” at least in some examples refers to and/or is interchangeable with the terms “device”, “component”, “sub-system”, and/or the like.

The term “user equipment” or “UE” at least in some examples refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, station, mobile station, mobile user, subscriber, user, remote station, access agent, user agent, receiver, radio equipment, reconfigurable radio equipment, reconfigurable mobile device, and the like. Furthermore, the term “user equipment” or “UE” includes any type of wireless/wired device or any computing device including a wireless communications interface. Examples of UEs, client devices, and the like, include desktop computers, workstations, laptop computers, mobile data terminals, smartphones, tablet computers, wearable devices, machine-to-machine (M2M) devices, machine-type communication (MTC) devices, Internet of Things (IoT) devices, embedded systems, sensors, autonomous vehicles, drones, robots, in-vehicle infotainment systems, instrument clusters, onboard diagnostic devices, dashtop mobile equipment, electronic engine management systems, electronic/engine control units/modules, microcontrollers, control module, server devices, network appliances, head-up display (HUD) devices, helmet-mounted display devices, augmented reality (AR) devices, virtual reality (VR) devices, mixed reality (MR) devices, and/or other like systems or devices.

The term “network access node” or “NAN” at least in some examples refers to a network element in a radio access network (RAN) responsible for the transmission and reception of radio signals in one or more cells or coverage areas to or from a UE or station. A “network access node” or “NAN” can have an integrated antenna or may be connected to an antenna array by feeder cables. Additionally or alternatively, a “network access node” or “NAN” includes specialized digital signal processing, network function hardware, and/or compute hardware to operate as a compute node. In some examples, a “network access node” or “NAN” may be split into multiple functions (e.g., RAN functions) or functional blocks operating in software for flexibility, cost, and performance. In some examples, a “network access node” or “NAN” may be a base station (e.g., an evolved Node B (eNB) or a next generation Node B (gNB)), an access point and/or wireless network access point, router, switch, hub, radio unit or remote radio head, Transmission Reception Point (TRP), a gateway device (e.g., Residential Gateway, Wireline 5G Access Network, Wireline 5G Cable Access Network, Wireline BBF Access Network, and the like), network appliance, and/or some other network access hardware. The term “network controller” at least in some examples refers to a functional block that centralizes some or all of the control and management functionality of a network domain and may provide an abstract view of the network domain to other functional blocks via an interface. The term “access point” or “AP” at least in some examples refers to an entity that contains one station (STA) and provides access to the distribution services, via the wireless medium (WM) for associated STAs. An AP comprises a STA and a distribution system access function (DSAF).

The term “cell” at least in some examples refers to a radio network object that can be uniquely identified by a UE from an identifier (e.g., cell ID) that is broadcasted over a geographical area from a network access node (NAN). Additionally or alternatively, the term “cell” at least in some examples refers to a geographic area covered by a NAN. The term “camped on a cell” at least in some examples refers to a UE in idle mode that has completed a cell selection/reselection process and has chosen a cell; in some examples, the UE monitors system information and (in most cases) paging information. The term “serving cell” at least in some examples refers to a primary cell (PCell) for a UE in a connected mode or state (e.g., RRC_CONNECTED) and not configured with carrier aggregation (CA) and/or dual connectivity (DC). Additionally or alternatively, the term “serving cell” at least in some examples refers to a set of cells comprising zero or more special cells and one or more secondary cells for a UE in a connected mode or state (e.g., RRC_CONNECTED) and configured with CA. The term “primary cell” or “PCell” at least in some examples refers to a master cell group (MCG) cell, operating on a primary frequency, in which a UE either performs an initial connection establishment procedure or initiates a connection re-establishment procedure. The term “primary SCG cell” at least in some examples refers to a secondary cell group (SCG) cell in which a UE performs random access when performing a reconfiguration with Sync procedure for DC operation. The term “primary secondary cell”, “primary SCG cell”, or “PSCell” at least in some examples refers to a primary cell of a secondary cell group (SCG). The term “conditional PSCell addition” or “CPA” at least in some examples refers to a PSCell addition procedure that is executed only when PSCell addition execution condition is met. The term “conditional PSCell change” or “CPC” at least in some examples refers to a PSCell change procedure that is executed only when PSCell change execution condition is met. The term “conditional PSCell addition or change” or “CPAC” at least in some examples refers to a CPA and/or a CPC. The term “secondary cell” or “SCell” at least in some examples refers to a cell providing additional radio resources on top of a special cell (SpCell) for a UE configured with carrier aggregation (CA). The term “special cell” or “SpCell” at least in some examples refers to a PCell for non-DC operation or refers to a PCell of an MCG or a PSCell of an SCG for DC operation. In some examples, the terms “PCell” and “PSCell” are collectively referred to as a “special cell”, “spCell”, or “SpCell”.

The term “master cell group” or “MCG” at least in some examples refers to a group of serving cells associated with a “Master Node” comprising a SpCell (PCell) and zero or more SCells. The term “secondary cell group” or “SCG” at least in some examples refers to a subset of serving cells comprising at least one primary SCell (PSCell) and zero or more SCells for a UE configured with dual connectivity (DC).

The term “handover” or “HO” at least in some examples refers to the transfer of a user's connection from one radio channel to another (can be the same or different cell). Additionally or alternatively, the term “handover” or “HO” at least in some examples refers to the process in which a radio access network changes the radio transmitters, radio access mode, and/or radio system used to provide the bearer services, while maintaining a defined bearer service QoS.

The term “Master Node” or “MN” at least in some examples refers to a NAN that provides control plane connection to a core network. The term “Secondary Node” or “SN” at least in some examples refers to a NAN providing resources to the UE in addition to the resources provided by an MN and/or a NAN with no control plane connection to a core network.

The term “E-UTEAN NodeB”, “eNodeB”, or “eNB” at least in some examples refers to a RAN node providing E-UTRA user plane (PDCP/RLC/MAC/PHY) and control plane (RRC) protocol terminations towards a UE, and connected via an S1 interface to the Evolved Packet Core (EPC). Two or more eNBs are interconnected with each other (and/or with one or more en-gNBs) by means of an X2 interface. The term “next generation eNB” or “ng-eNB” at least in some examples refers to a RAN node providing E-UTRA user plane and control plane protocol terminations towards a UE, and connected via the NG interface to the 5GC. Two or more ng-eNBs are interconnected with each other (and/or with one or more gNBs) by means of an Xn interface. The term “Next Generation NodeB”, “gNodeB”, or “gNB” at least in some examples refers to a RAN node providing NR user plane and control plane protocol terminations towards a UE, and connected via the NG interface to the 5GC. Two or more gNBs are interconnected with each other (and/or with one or more ng-eNBs) by means of an Xn interface. The term “E-UTRA-NR gNB” or “en-gNB” at least in some examples refers to a RAN node providing NR user plane and control plane protocol terminations towards a UE, and acting as a Secondary Node in E-UTRA-NR Dual Connectivity (EN-DC) scenarios (see e.g., 3GPP TS 37.340 v17.0.0 (2022 Apr. 15) (“[TS37340]”)). Two or more en-gNBs are interconnected with each other (and/or with one or more eNBs) by means of an X2 interface. The term “Next Generation RAN node” or “NG-RAN node” at least in some examples refers to either a gNB or an ng-eNB. The term “IAB-node” at least in some examples refers to a RAN node that supports new radio (NR) access links to user equipment (UEs) and NR backhaul links to parent nodes and child nodes. The term “IAB-donor” at least in some examples refers to a RAN node (e.g., a gNB) that provides network access to UEs via a network of backhaul and access links. The term “Transmission Reception Point” or “TRP” at least in some examples refers to an antenna array with one or more antenna elements available to a network located at a specific geographical location for a specific area.

The term “Central Unit” or “CU” at least in some examples refers to a logical node hosting radio resource control (RRC), Service Data Adaptation Protocol (SDAP), and/or Packet Data Convergence Protocol (PDCP) protocols/layers of an NG-RAN node, or RRC and PDCP protocols of the en-gNB that controls the operation of one or more DUs; a CU terminates an F1 interface connected with a DU and may be connected with multiple DUs. The term “Distributed Unit” or “DU” at least in some examples refers to a logical node hosting Backhaul Adaptation Protocol (BAP), F1 application protocol (F1AP), radio link control (RLC), medium access control (MAC), and physical (PHY) layers of the NG-RAN node or en-gNB, and its operation is partly controlled by a CU; one DU supports one or multiple cells, and one cell is supported by only one DU; and a DU terminates the F1 interface connected with a CU. The term “Radio Unit” or “RU” at least in some examples refers to a logical node hosting PHY layer or Low-PHY layer and radiofrequency (RF) processing based on a lower layer functional split. The term “split architecture” at least in some examples refers to an architecture in which an CU, DU, and/or RU are physically separated from one another. Additionally or alternatively, the term “split architecture” at least in some examples refers to a RAN architecture such as those discussed in [TS38401], [TS38410], and/or [TS38473], the contents of each of which are hereby incorporated by reference in their entireties. The term “integrated architecture at least in some examples refers to an architecture in which an RU and DU are implemented on one platform, and/or an architecture in which a DU and a CU are implemented on one platform.

The term “network function” or “NF” at least in some examples refers to a functional block within a network infrastructure that has one or more external interfaces and a defined functional behavior. The term “Application Function” or “AF” at least in some examples refers to an element or entity that interacts with a 3GPP core network in order to provide services. Additionally or alternatively, the term “Application Function” or “AF” at least in some examples refers to an edge compute node or ECT framework from the perspective of a 5G core network. The term “virtualized network function” or “VNF” at least in some examples refers to an implementation of an NF that can be deployed on a Network Function Virtualization Infrastructure (NFVI). The term “Network Functions Virtualization Infrastructure Manager” or “NFVI” at least in some examples refers to a totality of all hardware and software components that build up the environment in which VNFs are deployed.

The term “virtualization container”, “execution container”, or “container” at least in some examples refers to a partition of a compute node that provides an isolated virtualized computation environment. The term “OS container” at least in some examples refers to a virtualization container utilizing a shared Operating System (OS) kernel of its host, where the host providing the shared OS kernel can be a physical compute node or another virtualization container. Additionally or alternatively, the term “container” at least in some examples refers to a standard unit of software (or a package) including code and its relevant dependencies, and/or an abstraction at the application layer that packages code and dependencies together. Additionally or alternatively, the term “container” or “container image” at least in some examples refers to a lightweight, standalone, executable software package that includes everything needed to run an application such as, for example, code, runtime environment, system tools, system libraries, and settings. The term “virtual machine” or “VM” at least in some examples refers to a virtualized computation environment that behaves in a same or similar manner as a physical computer and/or a server. The term “hypervisor” at least in some examples refers to a software element that partitions the underlying physical resources of a compute node, creates VMs, manages resources for VMs, and isolates individual VMs from each other.

The term “protocol” at least in some examples refers to a predefined procedure or method of performing one or more operations. Additionally or alternatively, the term “protocol” at least in some examples refers to a common means for unrelated objects to communicate with each other (sometimes also called interfaces). The term “communication protocol” at least in some examples refers to a set of standardized rules or instructions implemented by a communication device and/or system to communicate with other devices and/or systems, including instructions for packetizing/depacketizing data, modulating/demodulating signals, implementation of protocols stacks, and/or the like. The term “protocol stack” at least in some examples refers to an implementation of a protocol suite or protocol family. In various implementations, a protocol stack includes a set of protocol layers, where the lowest protocol deals with low-level interaction with hardware and/or communications interfaces and each higher layer adds additional capabilities. Additionally or alternatively, the term “protocol” at least in some examples refers to a formal set of procedures that are adopted to ensure communication between two or more functions within the within the same layer of a hierarchy of functions.

The term “session layer” at least in some examples refers to an abstraction layer that controls dialogues and/or connections between entities or elements, and may include establishing, managing and terminating the connections between the entities or elements. The term “transport layer” at least in some examples refers to a protocol layer that provides end-to-end (e2e) communication services such as, for example, connection-oriented communication, reliability, flow control, and multiplexing. Examples of transport layer protocols include datagram congestion control protocol (DCCP), fibre channel protocol (FBC), Generic Routing Encapsulation (GRE), GPRS Tunneling (GTP), Micro Transport Protocol (pTP), Multipath TCP (MPTCP), MultiPath QUIC (MPQUIC), Multipath UDP (MPUDP), Quick UDP Internet Connections (QUIC), Remote Direct Memory Access (RDMA), Resource Reservation Protocol (RSVP), Stream Control Transmission Protocol (SCTP), transmission control protocol (TCP), user datagram protocol (UDP), and/or the like.

The term “network layer” at least in some examples refers to a protocol layer that includes means for transferring network packets from a source to a destination via one or more networks. Additionally or alternatively, the term “network layer” at least in some examples refers to a protocol layer that is responsible for packet forwarding and/or routing through intermediary nodes. Additionally or alternatively, the term “network layer” or “internet layer” at least in some examples refers to a protocol layer that includes interworking methods, protocols, and specifications that are used to transport network packets across a network. As examples, the network layer protocols include internet protocol (IP), IP security (IPsec), Internet Control Message Protocol (ICMP), Internet Group Management Protocol (IGMP), Open Shortest Path First protocol (OSPF), Routing Information Protocol (RIP), RDMA over Converged Ethernet version 2 (RoCEv2), Subnetwork Access Protocol (SNAP), and/or some other internet or network protocol layer. The term “link layer” or “data link layer” at least in some examples refers to a protocol layer that transfers data between nodes on a network segment across a physical layer. Examples of link layer protocols include logical link control (LLC), medium access control (MAC), Ethernet, RDMA over Converged Ethernet version 1 (RoCEv1), and/or the like.

The term “radio resource control”, “RRC layer”, or “RRC” at least in some examples refers to a protocol layer or sublayer that performs system information handling; paging; establishment, maintenance, and release of RRC connections; security functions; establishment, configuration, maintenance and release of Signaling Radio Bearers (SRBs) and Data Radio Bearers (DRBs); mobility functions/services; QoS management; and some sidelink specific services and functions over the Uu interface (see e.g., 3GPP TS 36.331 v17.5.0 (2023 Jul. 4) and/or 3GPP TS 38.331 v17.5.0 (2023 Jul. 1) (“[TS38331]”)).

The term “Service Data Adaptation Protocol”, “SDAP layer”, or “SDAP” at least in some examples refers to a protocol layer or sublayer that performs mapping between QoS flows and a data radio bearers (DRBs) and marking QoS flow IDs (QFI) in both DL and UL packets (see e.g., 3GPP TS 37.324 v17.0.0 (2022 Apr. 13). The term “Packet Data Convergence Protocol”, “PDCP layer”, or “PDCP” at least in some examples refers to a protocol layer or sublayer that performs transfer user plane or control plane data; maintains PDCP sequence numbers (SNs); header compression and decompression using the Robust Header Compression (ROHC) and/or Ethernet Header Compression (EHC) protocols; ciphering and deciphering; integrity protection and integrity verification; provides timer based SDU discard; routing for split bearers; duplication and duplicate discarding; reordering and in-order delivery; and/or out-of-order delivery (see e.g., 3GPP TS 36.323 v17.2.0 (2023 Jan. 13) and/or 3GPP TS 38.323 v17.5.0 (2023 Jun. 30)).

The term “radio link control layer”, “RLC layer”, or “RLC” at least in some examples refers to a protocol layer or sublayer that performs transfer of upper layer PDUs; sequence numbering independent of the one in PDCP; error Correction through ARQ; segmentation and/or re-segmentation of RLC SDUs; reassembly of SDUs; duplicate detection; RLC SDU discarding; RLC re-establishment; and/or protocol error detection (see e.g., 3GPP TS 36.322 v17.0.0 (2022 Apr. 15) and 3GPP TS 38.322 v17.3.0 (2023 Jun. 30)).

The term “medium access control protocol”, “MAC protocol”, or “MAC” at least in some examples refers to a protocol that governs access to the transmission medium in a network, to enable the exchange of data between stations in a network. Additionally or alternatively, the term “medium access control layer”, “MAC layer”, or “MAC” at least in some examples refers to a protocol layer or sublayer that performs functions to provide frame-based, connectionless-mode (e.g., datagram style) data transfer between stations or devices. Additionally or alternatively, the term “medium access control layer”, “MAC layer”, or “MAC” at least in some examples refers to a protocol layer or sublayer that performs mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ (one HARQ entity per cell in case of CA); priority handling between UEs by means of dynamic scheduling; priority handling between logical channels of one UE by means of logical channel prioritization; priority handling between overlapping resources of one UE; and/or padding (see e.g., 3GPP TS 36.321 v17.5.0 (2023 Jun. 30), and 3GPP TS 38.321 v17.5.0 (2023 Jun. 30)).

The term “physical layer”, “PHY layer”, or “PHY” at least in some examples refers to a protocol layer or sublayer that includes capabilities to transmit and receive modulated signals for communicating in a communications network (see e.g., 3GPP TS 36.201 v17.0.0 (2022 Mar. 31), and 3GPP TS 38.201 v17.0.0 (2022 Jan. 5)).

The term “access technology” at least in some examples refers to the technology used for the underlying physical connection to a communication network. The term “radio access technology” or “RAT” at least in some examples refers to the technology used for the underlying physical connection to a radio based communication network. The term “radio technology” at least in some examples refers to technology for wireless transmission and/or reception of electromagnetic radiation for information transfer. The term “RAT type” at least in some examples may identify a transmission technology and/or communication protocol used in an access network. Examples of access technologies include wired access technologies, RATs, fiber optics networks, digital subscriber line (DSL), coax-cable access technologies, hybrid fiber-coaxial (HFC) technologies, and/or the like.

The term “channel” at least in some examples refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” at least in some examples refers to a connection between two devices through a RAT for the purpose of transmitting and receiving information.

The term “carrier” at least in some examples refers to a modulated waveform conveying one or more physical channels (e.g., physical channels of 5G/NR, E-UTRA/LTE, UTRA, GSM/EDGE, and/or the like). The term “carrier frequency” at least in some examples refers to the center frequency of a cell.

The term “bearer” at least in some examples refers to an information transmission path of defined capacity, delay, bit error rate, and/or the like. The term “radio bearer” at least in some examples refers to the service provided by Layer 2 (L2) for transfer of user data between user equipment (UE) and a radio access network (RAN). The term “radio access bearer” at least in some examples refers to the service that the access stratum provides to the non-access stratum for transfer of user data between a UE and a CN.

The terms “instantiate,” “instantiation,” and the like at least in some examples refers to the creation of an instance. In some examples, an “instance” also at least in some examples refers to a concrete occurrence of an object, which may occur, for example, during execution of program code. The term “reference point” at least in some examples refers to a conceptual point at the conjunction of two non-overlapping functional groups, elements, or entities. The term “reference” at least in some examples refers to data useable to locate other data and may be implemented a variety of ways (e.g., a pointer, an index, a handle, a key, an identifier, a hyperlink, and/or the like).

The term “use case” at least in some examples refers to a description of a system from a user's perspective. Use cases sometimes treat a system as a black box, and the interactions with the system, including system responses, are perceived as from outside the system. In some examples, use cases avoid technical jargon, preferring instead the language of the end user or domain expert. The term “user” at least in some examples refers to an abstract representation of any entity issuing commands, requests, and/or data to a compute node or system, and/or otherwise consumes or uses services. Additionally or alternative, the term “user” at least in some examples refers to an entity, not part of a 3GPP system, which uses 3GPP system services (e.g., a person using a 3GPP system mobile station as a portable telephone). The term “user profile” at least in some examples refers to a set of information used to provide a user with a consistent, personalized service environment, irrespective of the user's location or the terminal used (within the limitations of the terminal and the serving network).

The term “datagram” at least in some examples at least in some examples refers to a basic transfer unit associated with a packet-switched network; a datagram may be structured to have header and payload sections. The term “datagram” at least in some examples may be synonymous with any of the following terms, even though they may refer to different aspects: “data unit”, a “protocol data unit” or “PDU”, a “service data unit” or “SDU”, “frame”, “packet”, a “network packet”, “segment”, “block”, “cell”, “chunk”, “Type Length Value” or “TLV”, and/or the like. Examples of datagrams, network packets, and the like, include internet protocol (IP) packet, Internet Control Message Protocol (ICMP) packet, UDP packet, TCP packet, SCTP packet, ICMP packet, Ethernet frame, RRC messages/packets, SDAP PDU, SDAP SDU, PDCP PDU, PDCP SDU, MAC PDU, MAC SDU, BAP PDU. BAP SDU, RLC PDU, RLC SDU, WiFi frames as discussed in a IEEE protocol/standard (e.g., [IEEE80211] or the like), Type Length Value (TLV), and/or other like data structures. The term “packet” at least in some examples refers to an information unit identified by a label at layer 3 of the OSI reference model. In some examples, a “packet” may also be referred to as a “network protocol data unit” or “NPDU”. The term “protocol data unit” at least in some examples refers to a unit of data specified in an (N)-protocol layer and consisting of (N)-protocol control information and possibly (N)-user data.

The term “information element” or “IE” at least in some examples refers to a structural element containing one or more fields. Additionally or alternatively, the term “information element” or “IE” at least in some examples refers to a field or set of fields defined in a standard or specification that is used to convey data and/or protocol information. The term “field” at least in some examples refers to individual contents of an information element, or a data element that contains content. The term “data frame”, “data field”, or “DF” at least in some examples refers to a data type that contains more than one data element in a predefined order. The term “data element” or “DE” at least in some examples refers to a data type that contains one single data. Additionally or alternatively, the term “data element” at least in some examples refers to an atomic state of a particular object with at least one specific property at a certain point in time, and may include one or more of a data element name or identifier, a data element definition, one or more representation terms, enumerated values or codes (e.g., metadata), and/or a list of synonyms to data elements in other metadata registries. Additionally or alternatively, a “data element” at least in some examples refers to a data type that contains one single data.

The terms “configuration”, “policy”, “ruleset”, and/or “operational parameters”, at least in some examples refer to a machine-readable information object that contains instructions, conditions, parameters, and/or criteria that are relevant to a device, system, or other element/entity. The term “data set” or “dataset” at least in some examples refers to a collection of data; a “data set” or “dataset” may be formed or arranged in any type of data structure. In some examples, one or more characteristics can define or influence the structure and/or properties of a dataset such as the number and types of attributes and/or variables, and various statistical measures (e.g., standard deviation, kurtosis, and/or the like). The term “data structure” at least in some examples refers to a data organization, management, and/or storage format. Additionally or alternatively, the term “data structure” at least in some examples refers to a collection of data values, the relationships among those data values, and/or the functions, operations, tasks, and the like, that can be applied to the data. Examples of data structures include primitives (e.g., Boolean, character, floating-point numbers, fixed-point numbers, integers, reference or pointers, enumerated type, and/or the like), composites (e.g., arrays, records, strings, union, tagged union, and/or the like), abstract data types (e.g., data container, list, tuple, associative array, map, dictionary, set (or dataset), multiset or bag, stack, queue, graph (e.g., tree, heap, and the like), and/or the like), routing table, symbol table, quad-edge, blockchain, purely-functional data structures (e.g., stack, queue, (multi)set, random access list, hash consing, zipper data structure, and/or the like).

The term “synchronization signal blocl” or “SSB” at least in some examples refers to a synchronization signal (SS)/physical broadcast channel (PBCH) block as defined in [TS38211]. The term “SSB-based Measurement Timing configuration” or “SMTC” at least in some examples refers to an SSB-based measurement timing configuration configured by SSB-MeasurementTimingConfiguration as specified in [TS38331].

Aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

1-45. (canceled)

46. A user equipment (UE) configured for operation in a fifth-generation (5G) new-radio (NR) network, the UE comprising: processing circuitry; and memory, wherein the processing circuitry is configured to:
decode configuration information to configure the UE for operation in NR-NR Dual Connectivity (NR-DC) mode;
determine a carrier-specific scaling factor (CSSF_{outside_gap,i}) for inter-frequency measurements, the CSSF_{outside_gap,i} determined for a frequency range 1 (FR1)+FR1 NR-DC scenario comprising a Primary Cell (PCell) operating within the FR1 (FR1 PCell) and a Primary Secondary Cell (PSCell) operating within the FR1 (FR1 PSCell);
scale a measurement period based on the CSSF_{outside_gap,i}; and
perform the inter-frequency measurement outside measurement gaps during the scaled measurement period.

47. The UE of claim 46, wherein the inter-frequency measurements comprise one or more of an inter-frequency Synchronization Signal Block (SSB)-based measurement to be performed outside measurements gaps and an intra-frequency channel state information reference signal (CSI-RS) based layer 3 (L3) measurement.

48. The UE of claim 47, wherein the processing circuitry is to:
determine the CSSF_{outside_gap,i} to be 1+N_{PCC_CSIRS} for an FR1 primary component carrier (PCC),
wherein N_{PCC_CSIRS} is 1 if the FR1 PCC is only configured with the inter-frequency CSI-RS based L3 measurement or configured with both the inter-frequency CSI-RS based L3 measurement and the inter-frequency SSB-based measurement, and otherwise N_{PCC_CSIRS} is zero.

49. The UE of claim 47, wherein the processing circuitry is to:
determine the CSSF_{outside_gap,i} to be 2×(N_{SCC_SSB}+Y+2×N_{SCC_CSIRS}) for an FR1 secondary component carrier (SCC) or for an inter-frequency measurement object (MO) with no measurement gap, wherein:
N_{SCC_SSB} is a number of secondary cells (SCells) configured with only the inter-frequency SSB-based measurement to be measured without a measurement gap;
N_{SCC_CSIRS} is a number of SCells with both the inter-frequency SSB-based measurement and the inter-frequency CSI-RS based L3 measurement configured or with only the inter-frequency CSI-RS based L3 measurement configured; and
Y is a number of configured inter-frequency SSB-based frequency layers without a measurement gap that are to be measured outside of a measurement gap.

50. The UE of claim 47, wherein the processing circuitry is to:
determine the CSSF_{outside_gap,i} to be 2×(1+N_{PSCC_CSIRS}) for an FR1 primary secondary component carrier (PSCC),
wherein N_{PSCC_CSIRS} is 1 if the PSCC is configured with both the inter-frequency SSB-based measurement and the inter-frequency CSI-RS based L3 measurement or only configured with the inter-frequency CSI-RS based L3 measurement, and otherwise N_{PCC_CSIRS} is zero.

51. The UE of claim 47, wherein when the configuration information to configure the UE for operation in the NR-DC mode includes a measurement gap configuration, the processing circuitry is configured to determine a CSSF_{within_gap,I} for performing at least one of the inter-frequency SSB-based measurement and the inter-frequency CSI-RS based L3 measurement within measurement gaps.

52. The UE of claim 47, wherein the configuration information for operation in the NR-DC mode includes a first measurement configuration for a master cell group (MCG) cell operating in FR1 and a second measurement configuration for a secondary cell group (SCG) cell operating in FR1.

53. A non-transitory computer-readable storage medium that stores instructions for execution by processing circuitry of a user equipment (UE) configured for operation in a fifth-generation (5G) new-radio (NR) network, wherein the processing circuitry is configured to:
decode configuration information to configure the UE for operation in NR-NR Dual Connectivity (NR-DC) mode;
determine a carrier-specific scaling factor (CSSF_{outside_gap,i}) for inter-frequency measurements,
the CSSF_{outside_gap,i} determined for a frequency range 1 (FR1)+FR1 NR-DC scenario comprising a Primary Cell (PCell) operating within the FR1 (FR1 PCell) and a Primary Secondary Cell (PSCell) operating within the FR1 (FR1 PSCell); and
perform the inter-frequency measurement outside measurement gaps during a measurement period using the CSSF_{outside_gap,i}.

54. The non-transitory computer-readable storage medium of claim 53, wherein the inter-frequency measurements comprise one or more of an inter-frequency Synchronization Signal Block (SSB)-based measurement to be performed outside measurements gaps and an intra-frequency channel state information reference signal (CSI-RS) based layer 3 (L3) measurement.

55. The non-transitory computer-readable storage medium of claim 54, wherein the processing circuitry is to:
determine the CSSF_{outside_gap,i} to be 1+N_{PCC_CSIRS} for an FR1 primary component carrier (PCC),
wherein N_{PCC_CSIRS} is 1 if the FR1 PCC is only configured with the inter-frequency CSI-RS based L3 measurement or configured with both the inter-frequency CSI-RS based L3 measurement and the inter-frequency SSB-based measurement, and otherwise N_{PCC_CSIRS} is zero.

56. The non-transitory computer-readable storage medium of claim 55, wherein the processing circuitry is to:
determine the CSSF_{outside_gap,i} to be 2×(N_{SCC_SSB}+Y+2×N_{SCC_CSIRS}) for an FR1 secondary component carrier (SCC) or for an inter-frequency measurement object (MO) with no measurement gap, wherein:
N_{SCC_SSB} is a number of secondary cells (SCells) configured with only the inter-frequency SSB-based measurement to be measured without a measurement gap;
N_{SCC_CSIRS} is a number of SCells with both the inter-frequency SSB-based measurement and the inter-frequency CSI-RS based L3 measurement configured or with only the inter-frequency CSI-RS based L3 measurement configured; and
Y is a number of configured inter-frequency SSB-based frequency layers without a measurement gap that are to be measured outside of a measurement gap.

57. The non-transitory computer-readable storage medium of claim 56, wherein the processing circuitry is to:
determine the CSSF_{outside_gap,i} to be 2×(1+N_{PSCC_CSIRS}) for an FR1 primary secondary component carrier (PSCC),
wherein N_{PSCC_CSIRS} is 1 if the PSCC is configured with both the inter-frequency SSB-based measurement and the inter-frequency CSI-RS based L3 measurement or only configured with the inter-frequency CSI-RS based L3 measurement, and otherwise N_{PCC_CSIRS} is zero.

58. The non-transitory computer-readable storage medium of claim 54, wherein, when the configuration information to configure the UE for operation in the NR-DC mode includes a measurement gap configuration, the processing circuitry is configured to determine a CSSF_{within_gap,I} for performing at least one of the inter-frequency SSB-based measurement and the inter-frequency CSI-RS based L3 measurement within measurement gaps.

59. The non-transitory computer-readable storage medium of claim 58, wherein the configuration information for operation in the NR-DC mode includes a first measurement configuration for a master cell group (MCG) cell operating in FR1 and a second measurement configuration for a secondary cell group (SCG) cell operating in FR1.

60. A user equipment (UE) configured for operation in a fifth-generation (5G) new-radio (NR) network, the UE comprising: processing circuitry; and memory, wherein the processing circuitry is configured to:
decode configuration information to configure the UE for operation in NR-NR Dual Connectivity (NR-DC) mode;
determine a carrier-specific scaling factor (CSSF_{outside_gap,i}) for inter-frequency measurements, the CSSF_{outside_gap,i} determined for a frequency range 1 (FR1)+FR1 NR-DC scenario comprising a Primary Cell (PCell) operating within the FR1 (FR1 PCell) and a Primary Secondary Cell (PSCell) operating within the FR1 (FR1 PSCell);
scale a measurement period based on the CSSF_{outside_gap,i}; and
perform the inter-frequency measurement outside measurement gaps during the scaled measurement period,
wherein the inter-frequency measurements comprise one or more of an inter-frequency Synchronization Signal Block (SSB)-based measurement to be performed outside measurements gaps and an intra-frequency channel state information reference signal (CSI-RS) based layer 3 (L3) measurement, and
wherein when the configuration information to configure the UE for operation in the NR-DC mode includes a measurement gap configuration, the processing circuitry is configured to determine a CSSF_{within_gap,I} for performing at least one of the inter-frequency SSB-based measurement and the inter-frequency CSI-RS based L3 measurement within measurement gaps.

61. The UE of claim 60, wherein the processing circuitry is to:
determine the CSSF_{outside_gap,i} to be 2×(N_{SCC_SSB}+Y+2×N_{SCC_CSIRS}) for an FR1 secondary component carrier (SCC) or for an inter-frequency measurement object (MO) with no measurement gap, wherein:
N_{SCC_SSB} is a number of secondary cells (SCells) configured with only the inter-frequency SSB-based measurement to be measured without a measurement gap;
N_{SCC_CSIRS} is a number of SCells with both the inter-frequency SSB-based measurement and the inter-frequency CSI-RS based L3 measurement configured or with only the inter-frequency CSI-RS based L3 measurement configured; and
Y is a number of configured inter-frequency SSB-based frequency layers without a measurement gap that are to be measured outside of a measurement gap.
